(19) United States
(12) Patent Application Publication
(10) Pub. No.: US 2008/0047502 A1
(43) Pub. Date: Feb. 28, 2008

(54) Hybrid Cycle Electrolysis Power System with Hydrogen & Oxygen Energy Storage

(75) Inventor: Arthur P. Morse, Lansdale, PA (US)

Correspondence Address: THOMAS P O'CONNELL, 1026A MASSACHUSETTS AVENUE, ARLINGTON, MA, 02476, US

(73) Assignee: Michael L. Russo, Wilmington, MA (US)

(21) Appl. No.: 11/844,346

(22) Filed: Aug. 23, 2007

Related U.S. Application Data
(60) Provisional application No. 60/823,276, filed on Aug. 23, 2006.

(51) Int. Cl. F02B 43/10; C25B 1/04; F01N 3/00

(52) U.S. Cl. 123/3; 205/628; 60/320

(57) ABSTRACT

A method for generating power comprising the steps of feeding water into an electrolyzer, providing electricity to operate the electrolyzer to split at least some of the water into hydrogen and oxygen, and decompressing one or both of the hydrogen and oxygen to generate power. Water can be pressurized prior to being fed into the electrolyzer. The hydrogen and oxygen, which can be stored in insulated storage vessels, can be decompressed isentropically to yield energy, which can be used to power a generator. Heat can be extracted from the hydrogen and oxygen, such as through heat exchangers. Hydrogen and oxygen can combine in an internal combustion process to produce work and heat, which can be recycled into the thermodynamic process.

### RELATED APPLICATIONS

This application is related to U.S. Pat. No. 6,918,350, issued Jul. 19, 2005, to U.S. Pat. No. 7,228,812, issued Jun. 12, 2007, and co-pending application Ser. No. 11/734,357, filed Apr. 12, 2007, all disclosures being expressly incorporated herein by reference.

### BACKGROUND OF THE INVENTION

The Rankin, Auto, and Diesel cycles all involve huge inefficiencies due to heat loss. The percentage of potential energy present in the fuel actually converted to work is small. For example, the Rankin cycle is approximately 27 to 35% efficient, the Auto cycle is about 38 to 45% efficient, and the Diesel cycle is about 45 to 52% efficient. The Rankin cycle converts most of the energy supplied to the system by fuel into heat, which is drawn away in boiler exhaust stacks and through the steam condensing step for recycling liquid water back into the boiler. Even in a nuclear power plant that does not have an exhaust stack, over 60% of the input energy is drawn away during the condensing step. The Auto and Diesel cycles also lose efficiency in a similar manner to the Rankin cycle in that energy is lost in the exhaust gasses and through the engine block by, among other things, the radiator.

All combustion engines or power systems change the chemical composition of air. Given that air contains about 21% oxygen and 78% nitrogen and 1% argon, air is used to support combustion. Since nitrogen and argon are not commonly used in the chemical reaction, they are exhausted unchanged by weight. The formation of carbon dioxide, water, and other miscellaneous compounds is accomplished through combustion, which removes oxygen form the intake air. Exhaust gasses release depleting oxygen content and introducing greenhouse gases, such as CO₂, into the surrounding environment.

Hydrogen-fired engines typically use air to support combustion. These systems do not put substantial green house gasses into the air since the majority of the oxygen combines with hydrogen to produce heat and water vapor thereby sharply reducing the amount of oxygen by weight in the exhaust gasses compared to the intake air. Therefore, a hydrogen engine, although environmentally clean, still depletes the oxygen content in air by weight.

Most thermodynamic cycles are designed to function within the same medium. For example, the Rankin Cycle produces work by adding heat to water under high pressure until it boils. Additional energy superheats steam, which is then isentropically expanding to convert thermal energy into work to drive a prime mover such as a turbine or reciprocating steam engine. Residual steam condenses under low pressure, and liquid water recycles back into a boiler under high pressure to start the closed loop boiling cycle all over again. Waste energy is expended in two key stages. First, source energy comes from combusting fossil fuels generating greenhouse gasses and waste heat that exhausts into the environment through a stack. Second, waste heat exhausts through the condensing step by cold water circulating through the main condenser removing latent heat present in the low-pressure steam after expansion so that condensate can be recycled back to the boiler in a closed loop system.

The Auto and Diesel Cycles are open systems that compress air by means of a piston in a cylinder. As the up stroke compresses air, air temperature rises due to isentropic compression. Heat is then added at top dead center when fuel reacts with air and ignites, such as by spark plug or spontaneous combustion. The combustion process releases heat into air, which causes an isentropic expansion creating a power down stroke transferring heat energy into work. Fresh air replaces the spent air, and the cycle repeats. Exhaust air containing greenhouse gasses and waste heat expels into the atmosphere. Heat losses primarily occur in two areas. First, heat is lost through the exhaust step as it is carried away into the atmosphere by exhaust gases. Second, heat is absorbed through the engine block and expelled into the atmosphere through the engine jacket water/radiator cooling system or by cooling fins where the system is air-cooled.

A Gas turbine cycle is similar to the Auto and Diesel cycles in that it is an open system that compresses air. Fuel ignition releases heat into compressed air isentropically expanding air through turbine blades thereby creating a radial force and converting heat into work. Unlike the Rankin and reciprocating engine concepts, most of the heat is carried away through exhaust gases and through air exiting the back end of the turbine. Greenhouse gases and waste heat exit the turbine system at sufficient quantities to cool the turbine shell to prevent overheating.

All of the systems above operate using water, air, or both to absorb heat and expand it isentropically to convert heat into work. Only a fraction of the potential energy present in the fuel is converted to work. As a result, more than half of the potential energy is converted to waste heat. The more waste heat there is, the more fuel is needed to achieve an expected power output. Huge quantities of greenhouse gasses exhaust into the atmosphere due to the need to make up for lost energy. It will be appreciated that far less greenhouse gas would be generated if waste heat could be recovered and converted to work. Such a system would use less fuel to achieve a desired power output.

### SUMMARY OF THE INVENTION

Under the present invention, the wide energy swings common to wind, wave, or solar energy can be converted into potential energy, such as in the form of hydrogen and oxygen gas, by electrolysis. The hydrogen and oxygen gas can then be exploited, such as to generate conventional line current through thermal and chemical conversion processes. Waste heat can be recovered pursuant to the invention from water vapor and air as it exhausts from a prime mover, such as a reciprocating or rotary internal combustion engine, and recycled into work. Saturated steam present in exhaust gases can be condensed by a “latent heat of evaporation” recovery and recycling process where the recovered energy returns to the prime mover to improve fuel consumption. Additionally, the condensate can be recycled into an electrolyzer and split back into hydrogen and oxygen thereby further reducing operating costs of purchasing and purifying system feed water.

This semi-closed system is completely green; neither operational by-products nor oxygen depletion are introduced into the environment. The system is also highly efficient and requires low capital costs to construct and operate. The system can target commercial scale operations to satisfy energy needs for large-scale manufacturers, office buildings, public transportation facilities, and local residential areas.

The system can operate to produce work without chemically adding to or subtracting from air. Where the system utilizes both hydrogen and oxygen as fuel, additional oxygen is supplemented to air in the chemical reaction to support the complete reaction between hydrogen and oxygen by weight. Excess oxygen present in the air assures that all available hydrogen reacts. At the end of the reaction, the oxygen content at exhaust remains consistent with the intake air. The system only borrows air to assure complete combustion and transfers heat from the hydrogen and oxygen reaction to air, expanding air within an engine cylinder and converting heat into work. A high percentage of residual heat remaining in the air and water vapor exhausts from the engine and recycles through a heat exchanger that condenses water vapor and cools the air. Liquid water is returned to the electrolysis process as the remaining air vents into the atmosphere, possibly carrying waste heat.

This system is clean and could be considered the most environmentally friendly “green” combustion system ever designed. Since a hydrogen-fired engine runs cooler than a fossil-fuel-fired engine, most of the heat energy is absorbed in the water vapor being produced and exhausted. An oil pan is not needed thereby eliminating the risk of exhausting small traces of greenhouse gasses from burning oil. Still further, bearing surfaces can employ low friction material, such as Teflon, to limit bearing wear and heat.

The system is predicted to have an efficiency potentially ranging from 68 to 85%, far more efficient than any combustion engine process ever developed. Expected losses through friction, heat leakage, and water vapor loss at the exhaust step should be the only sources of inefficiency. With waste heat recovery features provided at the electrolyzer, decompressors, internal combustion engine, turbocharger or supercharger, exhaust recovery heat exchangers and purified feed water recycling, expected efficiencies should be far superior to any industrial power plant application.

Embodiments of the invention can be founded on an electrolyzer operable at high pressures, such as above 300 psia. The electrolyzer can separate purified water into hydrogen and oxygen under pressure. The higher the operating pressures, the better the efficiency and storage capacity of the system. System pressure can be maintained by a positive displacement pump, such as a gear pump.

Electrolysis can be carried out using an alkaline approach at high pressure with varying cell groups depending upon prime mover load and, potentially, with a static or dynamic catalyst/gas accumulators. Work can be generated by decompressing hydrogen and oxygen through a mechanical reciprocating conversion process, such as with a reciprocating decompressor operative over a wide temperature range. Insulated storage containers can avoid heat losses of hydrogen and oxygen gasses during compressed storage.

A condensation process can utilize low pressure/temperature hydrogen and oxygen to condense saturated steam into water while venting excess air exhausted from an internal combustion engine. The internal combustion engine can intake both hydrogen and oxygen as the primary fuel to expand intake air during combustion to create a “power down stroke” without changing the chemical composition of air after combustion, except for the adding of moisture content by weight. In further embodiments, a gas turbine can intake hydrogen and oxygen to expand compressed intake air during combustion to drive the turbine without depleting oxygen from air after combustion. Waste heat can be recovered down stream.

Hydrogen and oxygen can be transported from one location, such as the point of generation, to a second location, such as the point of consumption, to assure flexibility of the system and to enable maximum energy conversion and storage at the generation site and steady output at the demand site. Low quality alternating current, possibly not connected to the power grid, can be provided to localized power stations so it can be efficiently converted into a quality A/C output that consistently meets power grid and standard electrical component requirements. With this, hydrogen and oxygen storage and transport needs can be minimized.

It will be appreciated that the hybrid cycle electrolysis power systems disclosed herein are subject to widely varied embodiments. However, to ensure that one skilled in the art will be able to understand and, in appropriate cases, practice the present invention, certain preferred embodiments of the broader invention revealed herein are described below and shown in the accompanying drawing figures. Before any particular embodiment of the invention is explained in detail, it must be made clear that the following details of construction, descriptions of geometry, and illustrations of inventive concepts are mere examples of the many possible manifestations of the invention.

### BRIEF DESCRIPTION OF THE DRAWINGS

In the accompanying drawing figures:

FIG. 1 is a schematic view of a system pursuant to the invention disclosed herein;

FIG. 2 is a graph of temperature as water is pressurized;

FIG. 3A is a chart of the isentropic decompression of hydrogen;

FIG. 3B is a chart of the isentropic decompression of oxygen;

FIG. 4 is a chart depicting the transfer of energy under the method disclosed herein;

FIGS. 5A and 5B are charts of heat recovery through air and oxygen heat exchangers and through a hydrogen heat exchanger;

FIG. 6 is schematic view of a gas turbine system under the present invention;

FIG. 7 is a is a chart depicting the conversion of thermal energy into work;

FIGS. 8A and 8B are charts of heat recovery through air and oxygen heat exchangers and through a hydrogen heat exchanger;

FIG. 9 is a schematic view of a high pressure dynamic electrolysis system as disclosed herein;

FIG. 10 is a schematic view of an electrolyzer under the present invention;

FIG. 11 is a schematic view of an electrolyzer conductor securing system;

FIGS. 12A, 12B, and 12C are schematic views of accumulator details;

FIGS. 13A, 13B, and 13C are schematic views of electrolyzer cell arrangements;

FIG. 14 is a schematic view of a conductor and baffle assembly as taught hereunder;

FIG. 15 is a schematic view of an alternate conductor assembly;

FIGS. 16A, 16B, and 16C are schematic views of electrolyzer shell arrangements at taught herein; and

FIGS. 17A, 17B, and 17C are schematic views of cam system details under the instant invention.

### DETAILED DESCRIPTION OF PREFERRED EMBODIMENTS

It will be appreciated that the hybrid cycle electrolysis power systems disclosed herein are subject to widely varied embodiments. However, to ensure that one skilled in the art will be able to understand and, in appropriate cases, practice the present invention, certain preferred embodiments of the broader invention revealed herein are described below and shown in the accompanying drawing figures. Before any particular embodiment of the invention is explained in detail, it must be made clear that the following details of construction, descriptions of geometry, and illustrations of inventive concepts are mere examples of the many possible manifestations of the invention.

The Hybrid Cycle disclosed herein using an internal combustion reciprocating or rotary engine can follow the thermodynamic steps summarized below.

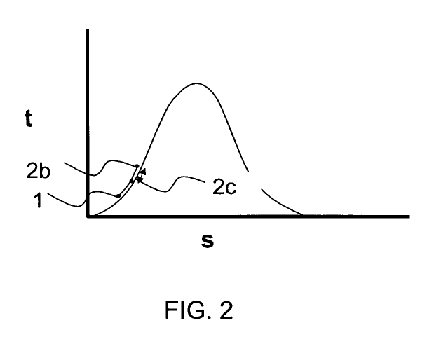

Pressurization: Energy added to purified water at ambient temperature and pressure is pressurized and fed into an electrolyzer following the graph of FIG. 2.

Electrolysis: Electrical energy is added to the electrolyzer to separate water into hydrogen and oxygen. Approximately 80% of the energy is consumed in the chemical separation of hydrogen and oxygen. The balance of the energy transfers into the electrolyzer solution and increases the temperature pursuant to FIG. 2. The heat of electrolysis can be removed and controlled by bleeding warm hydrogen and oxygen gas from the electrolyzer to carry heat adiabatically into insulated storage containers. Additionally, cool feed water can be fed into the electrolyzer absorbs additional heat.

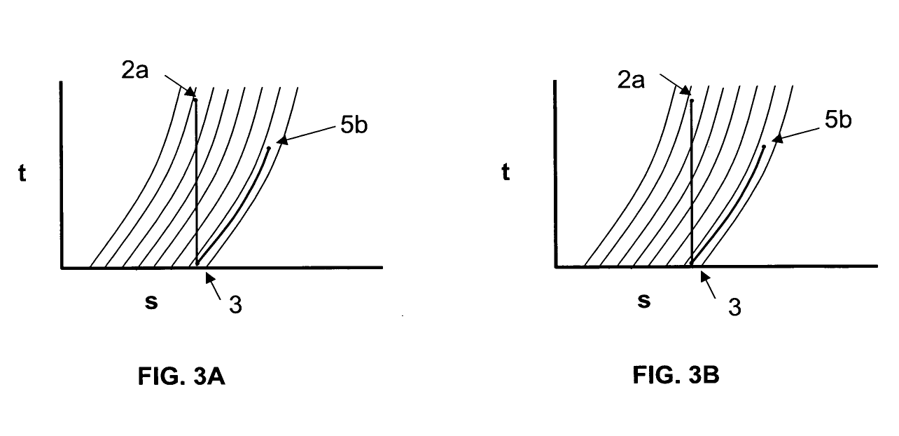

Decompression: Hydrogen and Oxygen gas are decompressed isentropically thereby converting thermal energy into work to drive a generator pursuant to FIGS. 3A and 3B.

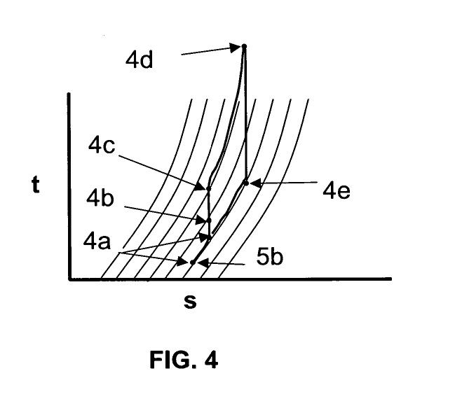

Combustion: Hydrogen and Oxygen chemically combine in an internal combustion process and transfer the heat of combustion to air to expand the air and convert thermal energy into work to drive an electric generator as graphed in FIG. 4.

The air cycle process can include the step of pre-heating intake air by recycling waste heat from the hot exhaust gasses generated by an internal combustion process through a heat exchanger prior to intake into the internal combustion process. A turbocharger can compress intake air by converting waste heat of exhaust gases into work increasing compression temperatures and volumes and aiding fuel efficiency. A normal compression cycle can then occur thereby elevating internal pressures and temperatures. Ignition transfers thermal energy for combustion between hydrogen and oxygen into air under pressure in the combustion chamber. Expansion occurs where more energy converts to work due to pre-heating and pre-compression. Liquid water injection can absorb excess heat of combustion regulating engine operating temperature by flashing into saturated steam and creating an isentropic expansion in the combustion chamber supplementing air expansion in the chamber and improving fuel efficiencies.

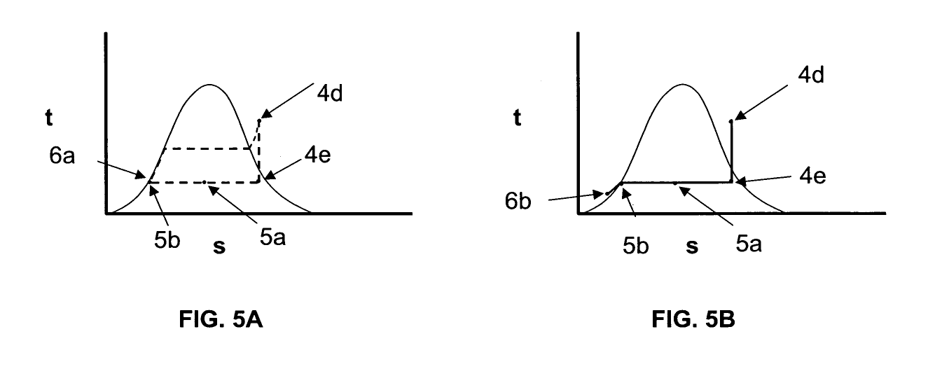

Heat can be recovered through air and oxygen heat exchangers. With the Air Heat Exchanger, latent heat in steam present in the exhaust gases reduces and recycles back into the internal combustion process as shown in FIGS. 4, 5A, and 5B. With the Oxygen Heat Exchanger, cold oxygen, post decompression, absorbs energy by recycling waste heat from hot exhaust gases generated by an internal combustion process warming to approximately ambient temperature through two heat exchangers prior to intake into the internal combustion process. Also, liquid water is condensed from exhaust gases recycling waste heat into fuel, namely oxygen, to supply the internal combustion process. In addition, exhaust air cools to near ambient temperature and exhausts into the atmosphere with little to no oxygen depletion.

Heat can also be recovered through a hydrogen heat exchanger. Hot condensate partially recycles back into the internal combustion process as it is pressurized and atomized in the combustion chamber through water injection as illustrated in FIG. 5A. The remaining hot condensate cools to approximately ambient temperature through a third heat exchanger recycling waste heat into hydrogen to fuel the internal combustion process, which again can be understood with reference to FIGS. 5A and 5B. Cool condensate stores adiabatically and eventually recycles back into the electrolyzer.

The hybrid cycle disclosed herein uses multiple mediums to complete a “semi-closed” loop thermodynamic cycle. Advantages of this cycle include that no greenhouse gasses are generated, oxygen content in air does not deplete since air is merely borrowed, and potential energy either initially converts into work or is recovered and recycled and then converted to into work. Heat recovery occurs at several points in the cycle thereby resulting in most of the potential energy being converted to work.

Unlike the Sterling Cycle, which itself is efficient and clean, the present cycle is more practical in an industrial setting given, particularly since the footprint of the prime mover per kilowatt is small, similar to present day internal combustion engines and turbines. A Sterling Engine requires a much larger footprint and a unique engine design for the same power output. Standard prime movers, such as compressors, internal combustion engines and gas turbines, can be modified to accommodate this hybrid cycle.

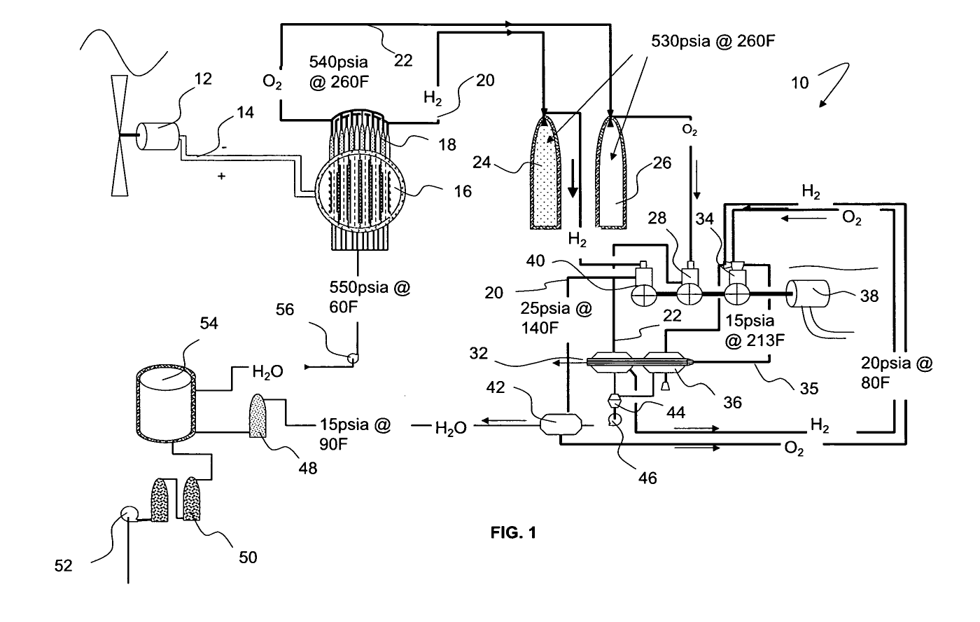

FIG. 1 depicts an embodiment of a system 10 carrying forth the hybrid cycle disclosed herein. The primary power source 12 can comprise a DC generator or AC alternator converted to DC through a full bridge rectifier. Although FIG. 1 illustrates a wind turbine as the power source 12, energy can derive from any suitable source including wind, ocean waves, and solar radiation. The generator power source 12 can be rotary or reciprocating provided the output is converted to direct current. Direct current is needed to supply power to an electrolyzer 16, which will convert kinetic energy in the form of electrical current to potential energy in the form of a fuel, namely hydrogen and oxygen. A power supply bus 14 can carry direct current from a generator power source 12 in close proximity to the electrolyzer 16 such as at a wind farm or wave harvesting system. In some cases, the power supply bus 14 may carry high voltage alternating current generated at a wind farm, stepped up and transmitted to a point of use, then stepped down and converted to direct current by a full bridge rectifier or equivalent.

Electrolysis has been well known for over a century. Among the unique aspects of the system 10 is that it operates under pressure and the load applied to the source generator will vary, such as by adjusting the number of active cell groups, depending upon the available power provided by the prime mover and generator assembly. Operation under pressure eliminates the need for compressors thus saving on energy losses typical of gas compression. Unit load can be varied to assure maximum efficiency. To prevent overloading the generator and stalling the prime mover 12 during low wind, wave, or solar activity, the number of active cell banks in the electrolyzer 16 can be reduced as described further hereinbelow. To take advantage of high wind, wave, or solar activity, the number of cell bank groups can be increased. A programmable controller could sense the available power provided by the prime mover 12 and adjust the load of the electrolyzer 16 to an optimum level.

Direct current is supplied to the electrolyzer 16 where water is split into hydrogen and oxygen. The electrolyzer 16 has an anode and cathode immersed in an alkaline solution consisting of purified water and potassium hydroxide, sodium hydroxide, or the like. Direct current ionizes the solution between an anode and cathode to form hydrogen on the negative conductor and oxygen on the positive conductor. The gasses form small bubbles that float away from the conductors and collect into accumulators 18. Accumulators 18 separate gas bubbles from the alkaline solution, and the resulting gas transfers into storage vessels 24 and 26. The electrolysis can be carried out under pressure thereby avoiding energy losses common to prior art electrolyzers where capital and energy costs can be substantial in the process of achieving industry standard storage pressures.

Approximately 40 to 10% of the input energy will be absorbed into the water and gasses being produced due to electrical resistance present in the alkaline solution. Heat may build up in the solution and may require removal. The accumulators 18 will remove some heat through bleeding off production gases into gas storage containers 24 and 26. Cold feed water absorbs more heat as it supplies make-up water to the system 10. Any residual heat not removed by either method may require removal through heat exchangers 32 and 36, which can remove excess heat energy by radiation. Alkaline solution may be circulated out of the accumulators 18, passed through heat exchangers, and recycled back into the electrolyzer 16. Air can blow through the heat exchangers 32 and 36 to remove excess heat. Thermal controllers can adjust the speed of the fans to regulate a steady operating temperature of the electrolyzer 16, which will be discussed more fully hereinbelow. It is not considered ideal to circulate alkaline to remove excess heat from the system 10 by a heat exchanger due to the energy losses that will occur. Proposed methods for maximizing electrolysis efficiency and minimizing the need for waste heat removal are also described below.

The accumulators 18 can be spherical in shape to withstand the contemplated high operating pressures. They can operate at approximately the same pressure and temperature as the electrolyzer 16 and can be made of high tensile strength material, such as stainless steel or the like. There can be two accumulators 18 per cell group, one for hydrogen and one for oxygen. A combination of alkaline solution along with large and fine gas bubbles will fill the accumulators 18 independently on the hydrogen and oxygen sides. Gas bubbles form on the conductor surfaces until they combine and acquire sufficient buoyancy to travel up the side of the conductors to form a gas pocket at the top of the accumulators 18.

Gas will tend to displace a percentage of the alkaline solution within the accumulator interiors until the water level reduces to a specified point. Valves can open at the top of the accumulator 18 to bleed off excess gas as it accumulates to maintain a constant water level. Level sensors in the accumulator 18 and level controllers will autonomously control alkaline solution level heights for the hydrogen and oxygen accumulators 18. Control system resolution can be sufficient to assure a steady gas bleed and to avoid cycling. Gas bleed cycling may create pressure imbalances internal to the electrolyzer 16 thereby creating water flow through the electrolyzer membranes and resulting in a potential for cross-contamination. A steady bleed off can greatly reduce the potential for this potential dangerous situation. In addition, a dry pipe, which can comprise a membrane material, can be located at the top of the accumulator 18 to remove alkaline solution droplets from the gases as they bubble up through the alkaline solution and collect at the top of the accumulator 18. Gas will bleed out of the accumulator 18 and route to the gas storage containers 24 and 26.

Where the electrolyzer 16 operates under pressure, gas can be transferred from the accumulators 18 to the storage vessels 24 and 26 by a bleed control valve located at the accumulator 18. In addition, the electrolyzer 16 will generate heat such that the gasses can be at the same temperature as the electrolyzer 16. Insulated supply lines 20 can retain this heat so that energy can transfer into work later in the process through the decompressors 28. Oxygen supply lines 22 can carry the oxygen gas.

Storage vessels 24 and 26 store hydrogen and oxygen gas as they transfer from the accumulators 18 at approximately the same internal pressure and temperature as they were in the accumulators 18. No compressor is needed. The higher the electrolyzer pressure, the higher the storage pressure. With this, more hydrogen and oxygen can be stored in a given volume. Insulated transfer lines 20 and 22 and storage tanks 24 and 26 adiabatically retain heat generated during the electrolysis process, which later is transferred into work during decompression.

Alternatively, hydrogen and oxygen can be isentropically compressed to store even more gas into a given space to minimize transport costs. The temperature will rise pursuant to ideal gas laws. The insulated containers 24 and 26 should maintain most of the heat energy present in the gases. During isentropic decompression, most of the work consumed during compression along with heat and pressure generated during the electrolysis process is recovered and converted into work during decompression. This approach may require a step approach where isentropic decompression extracts work then passes through a heat exchanger 32 to recover addition heat and then fully decompresses to maximize work output.

A decompression step isentropically can reduce the oxygen pressure to slightly above atmospheric pressure through a reciprocating or rotary prime mover 12 to extract work to drive an A/C line generator. Since the specific weight of oxygen is about 15 times heavier than hydrogen and slightly heavier than air, the power output on the oxygen side is about 12 to 16 times that of the hydrogen side. Approximately 35 to 55% of the total available work stored in the hydrogen and oxygen is present in the form of thermal energy, which can be transferred into mechanical work. Hydrogen and oxygen temperatures are reduced isentropically to well below 0° F., such as to −100 to −160° F. Insulated lines 20 and 22 transfer both hydrogen and oxygen adiabatically. Low pressure/cold gas recovers heat exhausted from an internal combustion process described below.

The alternate option discussed above may involve adding a compressor post electrolysis to boost the storage pressure and heat to reduce transport costs. Multiple decompressors 28 and 40 can convert thermal energy to work during decompression. As described above, cold gas passing through heat exchangers between decompression steps maximizes heat recovery efficiencies and convert a larger percentage of exhaust heat into work than a single reduction step.

In this alternate approach, the work recovered includes thermal energy from compression and electrolysis. Most of the work needed for compression will be recovered during decompression along with thermal energy from electrolysis. As isentropic decompression passes below the electrolyzer 16 pressure, the temperature will continue to decrease until atmospheric pressure is reached. Work is extracted through this entire process, and the end temperature will be approximately −100 to −160° F. as mentioned above. If heat is allowed to leak out during storage, the end temperature will be lower than indicated, and the amount of work converted in the decompression process will be less than it would have been if heat had not been lost. Therefore, adiabatic gas storage enhances total system performance.

It is desirable to store hydrogen and oxygen warm, such as above 200° F. However, if the gas temperature were to drop to ambient temperature during storage, the energy extracted during decompression will not be as much as at high temperatures. However, the process will still perform satisfactorily, and the system will nonetheless perform more efficiently than it would if the decompression step were not part of the system. In addition, the output temperature will be below the expected −100 to −160° F. To that end, the heat exchangers 32 would not warm the gases to ambient temperature as intended. Therefore, the internal combustion engine 34 would operate less efficiently. Although the system using cool fuel is designed to outperform prior art internal combustion systems, the hybrid system 10 will not perform as efficiently as intended. Therefore, efforts are necessary to assure adiabatic storage of hydrogen and oxygen.

The oxygen heat exchanger 32, which can comprise a condenser, is the second in a series of at least three heat exchangers 32, 36, and 42 that recover heat from exhaust gases produced from the internal combustion process. Cold oxygen passes through a condenser to absorb heat from saturated steam and air that is exhausting from the internal combustion engine 34. The first heat exchanger 32 will remove some heat from exhaust gases. Cold oxygen in the second heat exchanger 36 will remove the balance of the latent heat thus condensing the steam along with reducing air temperature to near atmospheric farther down stream within the same exchanger from where the steam is condensed out of the air. Oxygen warms to at least atmospheric temperature and possibly higher due to the opposing flow of the gasses internal to the exchanger 32. The warmed oxygen will assure more efficient fuel consumption in the internal combustion engine 34. Should cold oxygen be allowed to enter the engine cylinders, it would absorb heat from the intake air requiring more fuel to be burned to reach the same thermal expansion rates and, therefore, power output in the downward power stroke as it will with warmer fuel.

At the end of the oxygen heat exchanger 32, the remaining air in the exhaust lines will vent into the atmosphere, dried from the condensation step. Air will be substantially unchanged from the intake air given that the combustion process will contain supplemental oxygen to fully convert all available hydrogen atoms to water molecules as discussed below. Some residual heat may carry into the atmosphere at this step. Experimentation will determine the best operating pressures and temperatures to minimize waste heat.

Hydrogen and oxygen are metered into an internal combustion engine 34 to mix in the cylinder and combust, releasing energy through an exothermic chemical reaction. Where the additional oxygen supplied to the engine 34 will be sufficient to support full combustion of hydrogen, little to no oxygen is extracted from the intake air. Intake air is borrowed to provide excess oxygen to support combustion and to transfer heat from the chemical reaction into the air creating an expansion manifesting the down stroke and generating work. The internal combustion engine 34 isentropically expands air and water vapor, the product of the hydrogen and oxygen reaction in the form of saturated steam. The amount of work generated makes up an additional 45 to 55% of the potential energy present in the hydrogen and oxygen. An air and saturated steam mixture exhausts from the internal combustion engine 34 through an insulated exhaust pipe that adiabatically transfers the air and steam mixture to a series of heat exchangers 32, 36, and 42.

It should also be noted that the most efficient internal combustion engine 34 will transfer all or most of the waste energy through the exhaust pipe. Minimal or no energy will be lost through the engine block. This is possible with a hydrogen/oxygen fired engine because hydrogen burns very quickly, and the resulting water vapor contains most of the resulting energy. Where water vapor is saturated steam, the engine temperature is self-regulating to a degree based on the exhaust pressure. The higher the pressure, the higher the engine temperature, and vice-versa. Exhaust air, which is regulated in temperature by exhaust water vapor, carries excess heat away through the exhaust pipe 35.

Finely atomized, low volume water injection will also absorb excess heat, which would potentially comprise waste heat, into work by increasing the volume of expanding gases in the power stroke through an instantaneous expansion of atomized liquid water to saturated steam thereby aiding power stroke expansion and producing work. Experimentation will determine appropriate flow rates and mixtures of air and water injection for a given volume of fuel. To that end, the use of insulating material is an option to minimize uncontrolled heat loss and to maximize controlled heat carry through the exhaust pipe 35. Water used for water injection would be tapped from condensate after the second heat exchanger 36. The water is expected to be saturated liquid that will flash phase change into saturated vapor more readily than colder water thereby minimizing the impact on combustion chamber temperatures, such as might happen through a hampering of heat absorption of air during the power stroke.

The use of a turbocharger can also increase power output by providing more air volume to be expanded in the down stroke within the same space and increasing airflow through the engine 34. With this, more energy is moved out of the exhaust lines thereby preventing waste heat from escaping through the engine block while adding power to the down stroke. Isentropic compression of air will increase the intake air temperature to aid combustion by recovering most of the input work needed to compress air by converting it into output work. In addition, more airflow results through the first heat exchanger 32 extracting more heat from exhaust gases through the exchanger 32 than without a turbocharger.

The air heat exchanger 36 prepares exhaust gasses for condensation in the next heat exchanger 42 and to warm intake air intended for the internal combustion process to aid in fuel efficiency. Exhaust gasses consisting of saturated water vapor and air will be approximately at the boiling temperature of water at a given exhaust pipe pressure. For example, if the internal pressure in the exhaust pipe if 20 psia, the exhaust gas temperature is expected to be approximately 225 to 230° F.

Latent heat of evaporation needs to be removed to condense steam into water. Condensation will occur at the same exhaust temperature. Therefore, the exit temperature of the exhaust within the air heat exchanger 36 should be approximately the same as the inlet temperature. This is expected because the air heat exchanger 36 will not remove all of the latent heat present in the exhaust gasses. Removal and transfer of approximately 35 to 75% of the latent heat present in the exhaust gases will go into the intake air passing through the air heat exchanger 36.

If a turbocharger is added to the internal combustion engine 11, more air volume will pass through the air heat exchanger 12 removing a higher percentage of latent heat from the exhaust gases and making the overall system more efficient. Again, a turbocharger will recycle waste energy by isentropically increasing air pressure within the combustion chamber by supplying more air volume within the same space. The compression stroke will compress more air thus developing higher operating pressures and temperatures to make the combustion process more efficient and improve fuel economy.

A line generator 38 can be a standard AC generator connected to house distribution or to power grid distribution lines. The line generator 38 can be a conventional single, two or three phase generator designed to supply electrical A/C power over conventional distribution that meets all regulatory requirements for electrical power distribution such as voltage, frequency, phase, inductance, and amperage.

A hydrogen decompressor 40 can operate on the same principle as the oxygen decompressor 28 but can process twice as much volume. The total power output will be about 2 to 5% of the total system output. This output is significantly less than the oxygen decompresser 28 output due to the thermodynamic characteristics of hydrogen. The specific weight of hydrogen is about 6% that of oxygen such that it carries significantly less thermal energy at the same pressure and temperature. Isentropic decompression can be considered necessary to position hydrogen thermodynamically to absorb heat in the hydrogen heat exchanger 15. Although a 2 to 5% addition in power is not very significant in small systems, large systems will benefit greatly where small increases in power/efficiency translate economically substantial gains.

The main function of the hydrogen heat exchanger 42 is to remove residual heat from condensate, which can be lowered to approximately ambient temperature, and to warm hydrogen to approximately ambient temperature or higher to aid in fuel efficiency of the internal combustion engine 34 by recycling waste energy. The hydrogen heat exchanger 42 can be an opposing flow exchanger realizing temperature extremes on both ends of the exchanger 42 to maximize performance.

Lowering condensate temperatures to approximately ambient temperature accomplishes two functions. First, it is more efficient economically to recycle purified water than it is to continuously produce it from city or seawater. Condensate comprising recycled, purified water will require transport over distances to hydrogen and oxygen generation points so that energy ordinarily needed for water purification is conserved thereby increasing the thermal efficiency of the overall system. Second, recycling cool water into the electrolyzer 16 will maximize waste heat recovery in that system. Cool makeup feed water absorbs waste heat resident in the electrolyzer 16. In addition, the heat of electrolysis carries away from the electrolyzer 16 by hydrogen and oxygen gas transferring from the accumulators 18 to storage tanks 24 and 26.

Although the line generator rate is constant through a throttle control system, the fuel, air, and exhaust rates will fluctuate based on line current demand. Flow rates in all heat exchangers 32, 36, and 42 will fluctuate depending upon the demand for fuel of the internal combustion engine 34, which is determined by line current demand imposed on the line generator. The higher the demand, the more fuel and air consumed and the more exhaust generated. These fluctuations may change operating temperatures within the heat exchangers 32, 36, and 42.

A hot well 44 can collect condensate from the oxygen and air heat exchangers 32 and 36. Level control sensors in the hot well communicate to a programmable controller that regulates a draw pump 46 and maintains a water level within a specified range. The draw pump 46 can draw water away from the well 44 at a controlled rate and feed the filter and purified water storage tank 54.

A carbon filter 48 can remove contaminants from condensate preventing system contaminants from being recycled into the electrolyzer 16. Purer water will tend to enable more efficient electrolyzer 16 operation. Although condensate should be initially almost sterile, microbial counts will increase over time. A charcoal filter 48 inline to the electrolyzer 16 removes biological contaminants post storage and just prior to the feed pump 56.

Make-up water can come from a reservoir, the ocean, or any other source. The water will likely require purification before being supplied to the electrolysis process. A reverse osmosis system 50 or other means can provide adequate purification to prevent contaminants from reaching the electrolysis process. The inline filtration provided by the filter 48 will remove residual contaminants picked up in normal operation. The removal of contaminants in make-up water or recovery water will minimize the microbial count in the water minimizing the potential for microbial growth over time during storage and transport.

The reverse osmosis process can be powered by a high pressure positive displacement feed pump 52. The pump 52 can draw a significant amount of energy. Therefore, pump usage is minimized by recycling system condensate water. This is advantageous in that the cost of purification has already been incurred and since the system condensate is suitable for reuse in the electrolysis process. Condensate exiting the condenser adiabatically travels over insulated lines and into an insulated storage tank 54. Water is then stored and transported adiabatically until drawn by a positive displacement gear pump 56 charging the electrolyzer 16.

Liquid water at atmospheric pressure is pressurized by the positive displacement pump 56, which can comprise a gear pump. Temperature remains substantially unchanged due to the incompressibility of water. Pressurized water slightly above the electrolyzer pressure feeds the electrolyzer 16 at a high operating pressure, such as 200 psia or above. There can be one or more feed pumps 56 to support both sides of the electrolyzer 16. A slow, steady feed to maintain a zero pressure differential through the electrolyzer membranes minimizes the potential for cross-contamination between the hydrogen and oxygen sides of the electrolyzer 16. Pump performance can be controlled by a controller that senses both water levels and internal pressure differentials between the accumulators 18 to feed both accumulators 18 evenly. As water is added to the accumulators 18, gases present will be displaced by the new water increasing inter pressure. The pressure increase should trigger an increase in gas bleed off. A programmable controller can be employed to assure a steady even feed to the electrolyzer sides thereby avoiding imbalances that can create a cross flow at the membranes to maximize the safety of the system 10.

Storage tanks for water and gas can provide a system buffer that expands and contracts with changes in supply and demand. During times of high wind or wave energy activity, the electrolyzer 16 will place high demand on the consumption side of the system. The hydrogen and oxygen storage tanks 24 and 26 will absorb extra energy and will store it for future use. For low wind or wave activity when the electrolyzer 16 under-produces demand, excess hydrogen and oxygen already resident in the storage containers 24 and 26 will make up the difference of a negative supply and demand scenario.

To prevent energy losses during storage to achieve or attempt to achieve adiabatic storage, the storage vessels 24 and 26 can be insulated. Due to heat generated during electrolysis, the temperature of hydrogen and oxygen gas will be well higher than ambient temperature when exiting the electrolyzer 16. Thermodynamics dictates that the work conversion at the next step, decompression, will de dictated by temperature. The higher the gas temperature prior to decompression, the more work converts during that step. Insulating the gas storage containers 24 and 26 will ensure maximum work output during decompression. In addition, should hydrogen and oxygen be compressed above the electrolyzer pressure using a conventional compressor, adiabatic storage will retain the energy input through the compression process so that most of the energy can be recovered as work during decompression. If heat losses occur during storage, make-up energy can be provided by, for example, solar booster heaters, which can reside as part of the storage container system thereby maintaining gas storage temperatures at specified tolerance.

Make-up water in the water storage tank 54 will go through a reverse osmosis process to provide equivalent water quality as the recycled system water. Similar to gas storage, water storage will supply a reserve of feed water during high electrolyzer 16 activity periods and will store excess feed water during low activity periods of the electrolyzer 16.

The gas storage containers 24 and 26 perform the same function as the water storage container 54 does by performing as a buffer to allow gas inventory to grow or decline as the ratios between supply and demand change due to wind, wave, or other conditions compared to changes in demand. System design will strike a balance between supply and demand within a given tolerance and period assuring adequate and continual energy supplies the user need consistently throughout a year. The storage containers 24, 26, and 54 allow the link between supply and demand to be severed by eliminating a direct connection to the power grid, which serves at least two purposes. First, the separation enables remote energy harvesting, such as from the sea, of many more sites than prior art wind farms or wave harvesters that are connected directly to the power grid. To complement this, consumers of energy can be located in densely populated areas separated by miles to the point of generation. Second, the separation eliminates the need to synchronize supply and demand, which is required of prior art wind farms that supply power to the power grid in a method that typically does not take full advantage of all the energy available at any given time on the generation side during peak atmospheric periods and fails to satisfy demand during low activity periods. Energy storage allows the system to take full advantage of harvesting heavy sea and wind conditions that may exceed demand and supply previously stored power during low harvesting periods.

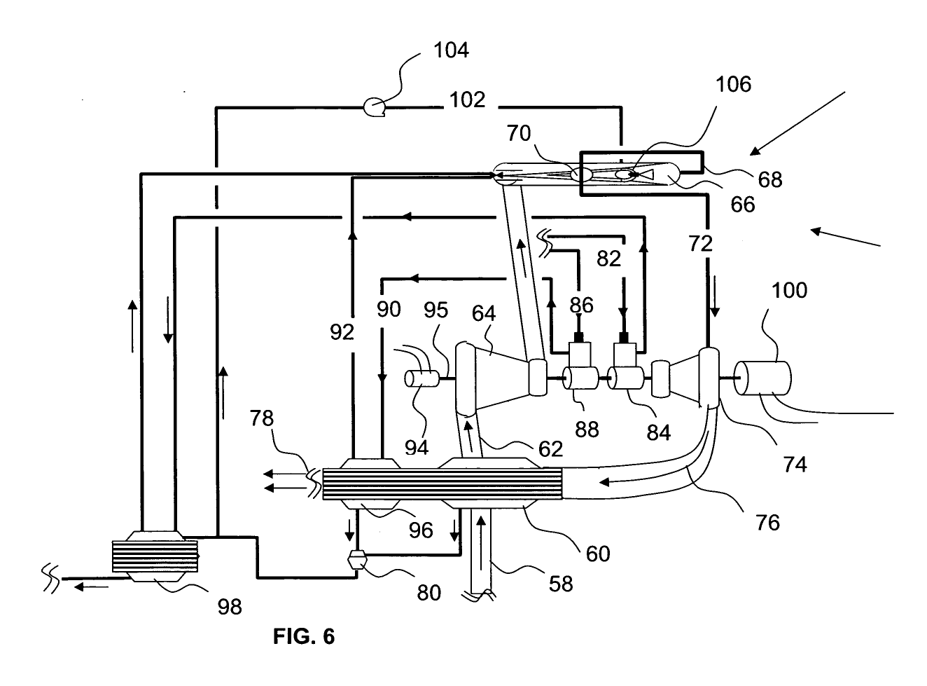

As shown in FIG. 6, the hybrid cycle can also be employed relative to a gas turbine 74 replacing the piston engine 34 with a combustion chamber 66 and super-heater 68 after combining compressed air, hydrogen, and oxygen for combustion. A super-heater 70 is post combustion and before the gas turbine 74. In addition, water injection may be used to control combustion chamber temperature and convert additional waste heat into work. The gas turbine approach is more applicable for larger industrial or commercial scale systems where a gas turbine 74 can generate a very large amount of power with a relatively small footprint with low cost and little maintenance. As with the internal combustion reciprocating engine approach, the gas turbine 74 can have low friction bearings employing low friction material.

The system 10 will take advantage of the waste-energy recovery concept discussed regarding the internal combustion engine approach where latent heat is recycled into the fuel supply to increase the energy output of the turbine 74 while condensing exhaust steam to be recycled back into the electrolyzer. As mentioned in the piston version above, the exhaust air will be of approximately the same quality as the intake air.

It will noted that a gas turbine 74 requires a large volume of air. Therefore, air intakes 58 are outside of building structures and contain air filters to minimize contaminants entering the system 10. The air heat exchanger 60 warms air prior to the compression step by transferring waste heat exhausted form the gas turbine 74 and recycling it back into the compressor intakes to improve combustion chamber fuel efficiency.

Another purpose of the heat exchanger 60 is to prepare exhaust gasses for condensation in the next heat exchanger 96 and to warm intake air intended for the internal combustion process to aid in fuel efficiency. Exhaust gasses consisting of saturated water vapor and air will be approximately at water boiling temperature at a given exhaust pipe pressure. For example, if the internal pressure in the exhaust pipe is 20 psia, the exhaust gas temperature is expected to be approximately 225 to 230 F. The exit temperature of the exhaust within the air heat exchanger should be approximately the same as the inlet temperature. This is expected because the air heat exchanger 60 will not remove all of the latent heat present in the exhaust gasses. Removal and transfer of approximately 35 to 75% of the latent heat present in the exhaust gases will go into the intake air passing through the exchanger 60.

Warm air, which can be under a small vacuum, leaves the heat exchanger 60 and enters the air compressor 64 having more energy at the starting point of compression than traditional methods. Although more energy will be required to compress air than traditional approaches, heat absorption of exhaust gases will begin the steam condensation process. Where air will be expanded in the turbine 74 at a higher temperature than it was when compressed due to heat absorbed in the combustion chamber, “work out” will exceed “work in”. As a result, preheating can be supported by the system 10. A priority of the system is to have the ability to condense and recover liquid water since purified water has more economic value than air. Therefore, recovering water can take priority over recovering all of the input energy out of air.

A rotary compressor 64 can rotate at a high RPM and isentropically compress air to between 60 and 100 psia, increasing the temperature. The compressor 64 will consume work to compress air, but the compressed air will enable a combustion process to initiate under pressure and will increase fuel efficiency.

The combustion chamber 66 will receive warm, compressed air from the compressor 64 and hydrogen/oxygen at approximately the same pressure as the incoming air. Warm air and fuel will extend the fuel efficiency of the combustion chamber 66. Combusted hydrogen and oxygen will transfer heat into the compressed air and water vapor causing air steam to expand. In addition, finely atomized water injection can absorb any excess heat of combustion that would not normally be transferred into the exhaust thereby converting extra heat into work. Water injection will increase expansion volumes in the gas turbine 74 and will control the operating temperature of the combustion chamber 66.

To add thermal efficiency to the gas turbine 74, gases leaving the combustion chamber 66 will be routed into a super heater 68 passing again though the combustion chamber 66, such as through tubes in the path of the plasma reaction. Superheated steam will maximize work out of the system 10 during thermal expansion in the turbine 74.

Superheating will increase steam temperature without increasing pressure. Where hydrogen burns so quickly and heat is dissipated quickly due to the formation of water vapor, a superheater 70 is placed directly in the combustion flame to absorb a percentage of the heat from combustion into the superheater 70 rather than the walls of the combustion chamber 66. Superheated steam and air under high pressure can feed into the gas turbine 74 through a feed line 72. The insulated line 72 will adiabatically transfer the energy to the gas turbine 74. The gas turbine 74 will convert energy to work in the form or rotary torque causing an isentropic pressure drop across the turbine 74 and will exit as a low pressure, lower temperature air and steam mixture. The gas turbine exhaust gases pass through an insulated line 76 into the air heat exchanger 60. The exhaust gas temperatures should be approximately that of saturated steam at predetermined output pressures, which are likely to be between 16 to 25 psia.

Where sufficient heat removal will occur through the air and oxygen heat exchangers 60 and 96 to condense exhaust steam, very little water vapor will vent into the atmosphere. The chemical composition of the venting air will be equivalent to intake air; there will be little to no oxygen depletion in the exhaust air. The system 10 will essentially borrow air providing excess oxygen for combustion and converting heat to work in the gas turbine 74.

As an option, where exhaust air will be practically the same chemical make-up as intake air, exhaust air may be rerouted back to the intakes 58 to adsorb any latent heat that may exist in the exhaust air to be supplied back into the gas turbine 74 and converted to work. Experimentation will be needed to determine how to control “heat run away”. It is believed that adjusting the pressure drop changes in the decompression step and potentially adding a radiator in the air recalculating line will likely control system temperature. In both scenarios, lowering exhaust air temperature as far as possible will assure maximum waste heat recovery and, therefore, maximum system efficiency.

Condensate formed in the air and oxygen heat exchangers 60 and 96 will collect in the condensate hot well 80. The hot condensate is then pumped away to a purified water storage tank once the water level reaches a specified level. Insulated condensate lines 90 and 92 and the hot well 80 will retain heat and add to thermal efficiency. As noted below, lowering condensate temperature to approximately ambient temperature will assure maximum waste heat recovery and maximum system efficiency.

Warm hydrogen under high pressure will pass through hydrogen line 82 and will enter into the hydrogen decompressor 84 to recycle heat energy collected from electrolysis into work. The decompressor 84 will convert potential energy in the form of heat and pressure into work through an isentropic pressure drop as described above for the internal combustion engine approach. Approximately 2 to 5% of the potential energy existing in the pressure vessels will convert into work in the form of rotary torque. Exiting hydrogen will be extremely cold and will route to the heat exchangers 98 to warm back up to approximately ambient temperature before routing to the combustion chamber 66 as fuel.

Warm oxygen under high pressure passes through oxygen line 86 and will enter into the oxygen decompressor 88 to recycle heat energy into work. The oxygen decompressor 88 will convert potential energy in the form of heat and pressure into work through an isentropic pressure drop as described for the internal combustion engine approach. Approximately 25 to 45% of the potential energy existing in the pressure vessels will convert into work in the form of rotary torque. Exiting oxygen will be extremely cold and will route to the heat exchangers 96 to warm back up to approximately ambient temperature before routing to the combustion chamber 66 to support combustion. Oxygen will transfer significantly more energy than hydrogen due to the thermodynamic properties of oxygen. Cold oxygen exiting the decompressor 88 will feed through an insulated line 90 to the oxygen heat exchanger 96 to absorb residual heat present in the gas turbine exhaust gases. As mentioned above, oxygen will absorb significantly more energy than the hydrogen side due to the thermodynamic properties of oxygen, thus condensing steam as it passes through the heat exchanger 96. Cold hydrogen exiting the decompressor 84 will feed through an insulated line 92 to the hydrogen heat exchanger 98 to absorb residual heat present in hot condensate. The more energy transferred, the more efficient the entire system 10.

To provide ease of starting, an electric motor 94 will turn the main shaft 95 while initiating the decompressors 84 and 88 and gas turbine starting sequences. The starter 94 can disengage when the turbine 74 and decompressors 84 and 88 begin operation and power up to their operating rates. The starter 94 can also turn the turbine 74 and decompressors 84 and 88 during shut down to promote even heat dissipation and prevent warping of the main shaft 95 as temperatures equalize.

The oxygen heat exchanger 96 can operate in substantially the same manner as already described above for the internal combustion engine concept. The volume of air and water vapor exhausting from a gas turbine 74 will be well beyond a reciprocating internal combustion engine. Therefore, the heat exchanger dimensions and number of passes will change according the volume needs but the overall function will be the same as for the reciprocating internal combustion engine application. Waste heat from the gas turbine exhaust gases will be absorbed into oxygen to make fuel consumption more efficient in the combustion process and to condense steam into liquid water to be eventually recycled back into the electrolyzer. Hydrogen will not absorb as much energy as oxygen but will contribute to the overall system efficiency especially for larger systems 10. The hydrogen heat exchanger 98 will cool condensate to approximately ambient temperature to maximize system efficiency.

Within the system 10, the gas turbine 74 and decompressors 84 and 88 are the prime movers for a line A/C generator 100. A percentage of hot condensate may be recycled back into the combustion chamber 66 through a recycling means 102 to control heat absorption and maximize fuel efficiency. The combustion chamber 66 can operate between 60 to 100 psia. Therefore, the recycled condensate will require pressurization, such as through a gear pump 104. An injector installed into the combustion chamber 66 will create backpressure to raise water pressure to the specified level. Water under pressure can be atomized by an atomizer 106 maximizing the surface area exposed to the hot gasses internal to the combustion chamber 66. The rate of heat absorption increases due to water atomization causing water to flash into steam thereby expanding the steam volume within the combustion chamber 66 and transferred into the gas turbine 74.

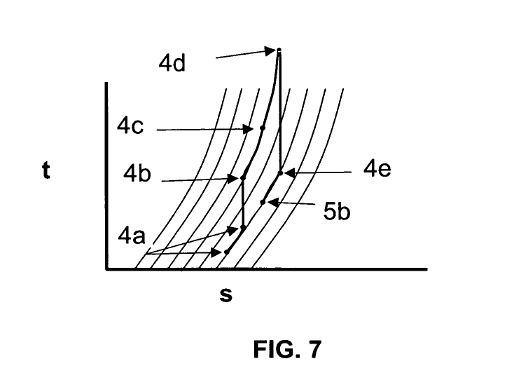

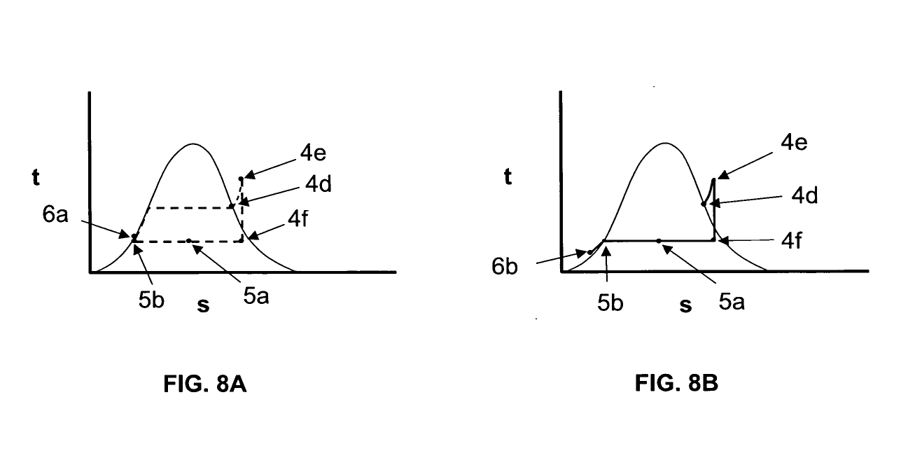

With reference to FIGS. 7 and 8, a thermodynamic description of the gas turbine concept and supporting equipment illustrates the differences between the gas turbine and reciprocating engine systems. Unlike the piston engine, the prime mover will not operate at low intake pressures thereby presenting new thermodynamic challenges. To compensate for this reduction in energy input into the intake air, a superheater can be added to maximize thermal efficiencies of the gas turbine. The thermodynamic steps can include the combination of Hydrogen and Oxygen in an internal combustion process.

The heat of combustion can expand air and convert thermal energy into work to drive an electric generator pursuant to FIG. 7. The air cycle process can proceed as follows:
a. Intake air pre-heats by passing through a heat exchanger 60 where waste heat from hot exhaust gases from the gas turbine 74 process transfers to the cool intake air to recycle waste heat back into the turbine 74.
b. Intake air isentropically compresses, such as by the compressor 64 driven by the turbine 74, increasing air temperature and pressure. Although the compressor 64 places a direct load on the turbine 74, the total energy output of the turbine 74 far exceeds the energy load paced by the compressor 64. Therefore, the compressor 64 will not stall the turbine 74.
c. Air temperature rises as in the combustion step at a constant pressure as the compressed air absorbs the heat of combustion. Ignition transfers thermal energy of combustion into air that is already under pressure. Liquid water injection absorbs excess heat of combustion to regulate the combustion chamber operating temperature by flashing into saturated steam.
d. Heat continues to be added in the superheater 68. Temperatures are regulated due to the presence of water vapor absorbing excess heat. The superheater 68 passes directly through the plasma stream of the hydrogen and oxygen reaction.
e. Expansion occurs where more energy converts to work due to the pre-heating, pre-compression, and superheating steps creation of a large isentropic expansion in the turbine chamber 66.

Heat can be recovered through air and oxygen heat exchangers 60 and 96. In the air heat exchanger 60, heat present in air and steam exhaust gasses recycles back into the intake air to feed the compressor 64 pursuant to FIGS. 8A and 8B. For the oxygen heat exchanger 96, cold oxygen warms, post decompression, by absorbing energy by recycling waste heat from hot exhaust gases to approximately ambient temperature to improve fuel efficiency in the combustion chamber 66. Also, liquid water is condensed from exhaust gases so that condensate can recycle back into the electrolysis process. The gap between 5b and 4a′ represents the total-heat loss. Exhaust air cools to as close to ambient temperature as possible to minimize heat loss through the air. Finally, air vents into the atmosphere with little to no oxygen depletion.

Heat can be recovered through the hydrogen heat exchanger 98. Hot condensate partially recycles back into the internal combustion process and is pressurized and atomized in the combustion chamber 66 as in FIG. 8. The remaining hot condensate cools to approximately ambient temperature through a third heat exchanger 98 to recycle waste heat into hydrogen thereby fueling the internal combustion process as shown in FIG. 5. Cool condensate transfers and stores adiabatically. Eventually, it recycles back into the electrolyzer through the above-described first step.

Again referring to FIG. 1, the electrolyzer 16 will preferably be a pressure vessel capable of supporting an internal pressure of 200 psia and higher. Where there will be some electrical resistance between the anode(s) and cathode(s), about 20% of the energy is expected to be transferred into the electrolyzer alkaline solution in the form of heat. This heat will be partially absorbed by cool feed water continually being added to the system 10. In addition, heat will carry away from the system 10 by warm hydrogen and oxygen bleeding away from the electrolyzer accumulators 18 transferring into gas storage containers 24 and 26. Vessel temperatures can be between 200 to 350° F.

In high pressure dynamic electrolysis powered by wind, wave, or sun, hydrogen and oxygen production will likely speed up and slow down with changes in the rate of wind, wave, or solar energy conversion. The main power supply can be in direct current. A change in power due to a change in current will change the rate of production.

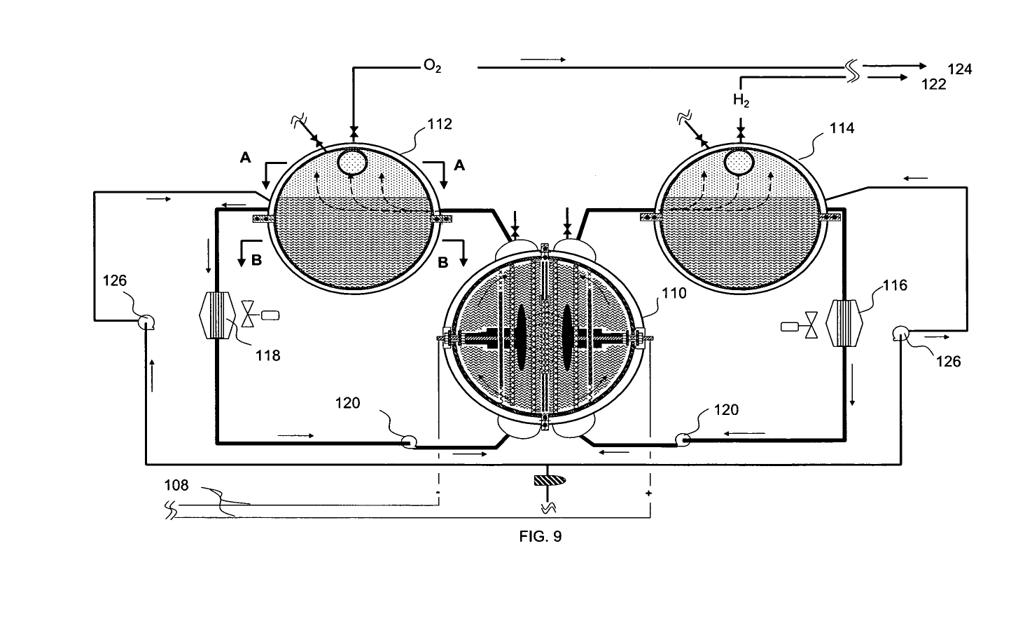

FIG. 9 details elements of a High Pressure Dynamic Electrolysis system. There, a direct current power supply 108 will supply the needed electrical power for electrolysis. Both voltage and current will vary depending upon the available energy to drive the system 10. Whether the method of prime mover is wind, wave, solar, or another form of energy, the amount of power available will vary by the moment and will determine the rate of hydrogen and oxygen production.

High pressure electrolysis can limit or eliminate the need for booster compressors to compress hydrogen and oxygen for storage purposes. Isentropic compression requires a significant amount of energy, much of which is lost as waste heat. High-pressure electrolysis eliminates the opportunities for friction losses common to compression and reduces the capital investment needed to fabricate the overall system 10.

To reduce the opportunity for gas contamination across the membranes, alkaline solution circulates through the electrolyzer 110 and draws away into accumulators 112 and 114 to separate gas from liquid. Fine gas bubbles are forced up and away from the membranes minimizing exposure time. Electrolyte circulation also channels gas away from the membranes further reducing the opportunity for cross contamination. The accumulators 112 and 114 allow electrolyte containing hydrogen or oxygen to pass through a multiplicity of membranes separating out gas form liquid. Gas bubbles accumulate at the top of the accumulators 112 and 114 and separate from the electrolyte. The operating pressure of the accumulators 112 and 114 is approximately the same as that of the electrolyzer 110.

It is anticipated that heat will be absorbed into the electrolyte. Typical electrolysis operates between 65 to 90% efficiency. Energy not absorbed into separating hydrogen and oxygen transfers into the electrolyte and gasses as heat. Heat draws away from the system 10 as gas bleeds out of the accumulators 112 and 114 and flows into storage containers. Cool make-up water absorbs heat as it continuously supplies the electrolyzer 110 as gas production draws water away from the system 10. Should this scenario be insufficient to remove all of the heat, inline heat exchangers 116 and 118 can remove the excess heat. The heat exchangers 116 and 118 can operate at approximately the same pressure as the electrolyzer 110 but function similar to a standard automobile radiator where air passes through the exchanger fins by conventional fan and motor assemblies.

Both the fan system of the heat exchangers 116 and 118 and circulating pumps 120 consume energy. Therefore, the concern about cross contamination combined with the added energy costs of minimizing the likelihood of contamination need to be weighed to determine the value of circulating electrolyte. The circulating pumps 120 move the electrolyte through the system 10 and provide the primary energy to create circulation.

As hydrogen accumulates, an alkaline level establishes in the hydrogen accumulator 112. Pressure builds until a pressure limit triggers a controller to open bleed valves located at the top of the accumulators 112 and 114 allowing gas to meter out of the accumulators 112 and 114 and into storage containers. Where hydrogen temperature will be above ambient temperature, a bleed line 122 can have thermal insulation to transfer the gas adiabatically to the storage containers. An oxygen bleed line 124 can perform the same function as the hydrogen bleed line 122 but for the oxygen side.

Make-up water feed pumps 126 create a pressure head by boosting purified water from atmospheric pressure to electrolyzer operating pressure, such as to 200 psia or higher. There can be a pump 126 for each side of the electrolyzer system 10. A tight pressure differential between the hydrogen and oxygen sides maintains a static electrolyte flow through the electrolyzer membranes. Where hydrogen production is twice as fast as oxygen production, water volume will differentiate between the sides. A programmable controller senses the pressure differentials between the sides and controls make up water supply to either side assuring a zero differential.

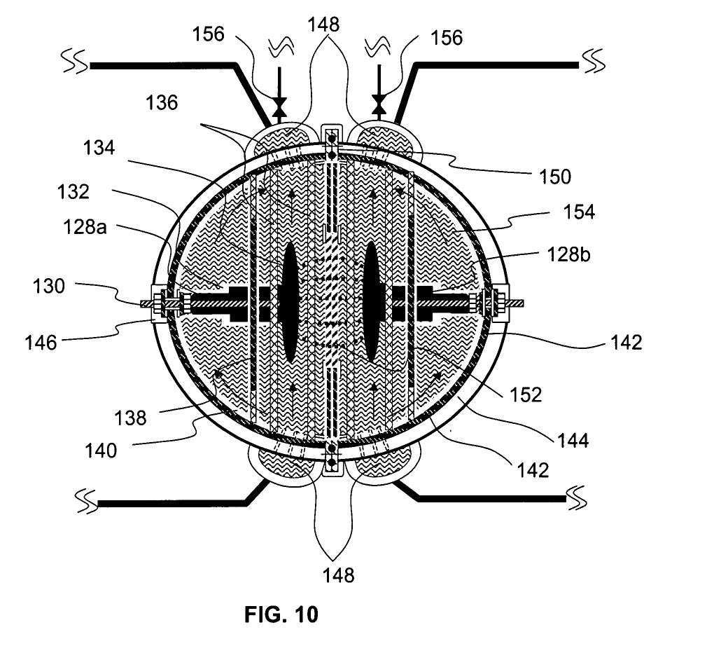

The electrolyzer 110 can be more fully understood with reference to FIG. 10. An anode and a cathode 128A and 128B can be milled to maximize surface area and can have a threaded interior. Graphite or a similar material will not break down during the electrolysis operation and is very conductive. Increasing the surface area exposure in the water will further reduce electrical resistance between the anode and cathode 128A and 128B thereby minimizing heat generation and maximizing hydrogen and oxygen production per kilowatt-hour of energy input. A male flare can be milled into the graphite anode and cathode conductors 128A and 128B to create a seal.

Stainless steel or equivalent material conductors 130 can be threaded into the graphite anode and cathode conductors 128A and 128B to create a solid mechanical and electrical connection. The conductors 130 mechanically secure the graphite anode and cathode conductors 128A and 128B to the electrolyzer shell and passes through a small hole in the shell to create a seal. A pressure seal can maintain structural integrity of the electrolyzer skin. The threaded conductors 130 will carry the main current to the graphite anode and cathode conductors 128A and 128B and therefore need to be insulated from the surrounding water to avoid plating of the metal during electrolysis.

Due to the dynamics of the electrolysis process, any metal that contacts the conductors 128A and 128B that carries a positive or negative charge and is exposed to the water will also become part of the circuit. Metal plating will occur. In other words, metal will be removed from the one conductor 128A or 128B and will be plated onto the other conductor 128B or 128A. As a result, one conductor 128A or 128B will decay in size and integrity while the other will grow. To prevent this, the stainless steel conductor 130 is insulated and sealed from the water internal to the electrolyzer 110. The graphite conductors 128A and 128B have male flare to create a surface to bond a seal 360-degrees around the stainless conductor 130 thus preventing plating.

Where alkaline solution will be flowing past the conductors 128A and 128B, their shape will be designed to maximize electrical surface area but to minimize eddy currents caused from water turbulence creating an opportunity for pooling or clouding of fine gas bubbles. The intent is to create a steady laminar flow throughout the internals of the electrolyzer 110 to prevent clouding.

Internal membranes 136 provide an added safety margin to the main baffle preventing the possible mixing of Hydrogen and Oxygen gasses while the gasses ascend to the top of the electrolyzer 110 forced by a laminar current flowing from the bottom to the top and out of the electrolyzer 110. Preventing mixing of hydrogen and oxygen internal to the electrolyzer 110 is paramount for safety reasons. To prevent cross contamination, two membranes 116 can extend the entire diameter of the electrolyzer 110 on both sides of the non-insulated portion of the anode(s) and cathode(s). The membranes 116 help channel the water flow and trap gas bubbles to create a first line of defense against cross contamination of gas bubbles from one side to the other.

A flange 138, which can be located on both sides of the electrolyzer 110, helps control the flow of the bulk of the water internal to the electrolyzer 110 to maximize the possibility of laminar flow. The flange 138 can be round and flat and can have pores in its outer quarter diameter. This porosity will allow some water to pass behind the flange 138 to fill the remaining space within the electrolyzer 110 to even the internal pressure. Some flow may be allowed through this space to prevent alkaline solution from pooling and forming contaminants. Although there may be alkaline solution flow behind this flange 138, the large majority of the alkaline solution laminar flow will be between the two internal membranes 136.

All metal surfaces internal to the electrolyzer 110 may have electrical insulation 140 to prevent plating such that the only electrically conductive surface without insulation would be the anode and cathode surfaces. Electricity will follow the path of least resistance. Therefore, the anode and cathode faces that are physically closest to one and other will contain the majority of the current flow. With this, the electrolyzer configuration alone will minimize plating. As an added precaution, internal insulation will assure 100% current flow between the anode and cathodes 128A and 128B.

The electrolyzer walls 142 may be made of stainless steel or composite materials, such as carbon fiber and insulating composite laminates, that provide sufficient structural integrity. Low cost materials are optional to control capital costs of construction. Given that the internal pressure will be 200 psia and higher, structural integrity, ASTM certified to operating and safety specifications, will be paramount to assure safety and a reliable, long operating life. The electrolyzer exterior can be insulated with thermal insulation 144 to control the flow of heat energy. Heat energy can be controlled to channel the majority of heat of electrolysis into the hydrogen and oxygen gases being generated to be converted to work later in the energy transfer process, namely during decompression.

The insulation 146 surrounding the terminals needs to be electrically resistant to prevent energizing the electrolyzer shell 142, which would create a safety issue. As an added safety precaution, the electrically conductive elements of the shell 142 will be grounded. Alkaline solution passing in and out of the electrolyzer 110 will pass through manifolds 148 to assure even, laminar flow through the electrolyzer interior from bottom to top. Separate manifolds 148, such as at least four in total and two per side, will assure separate laminar flow paths for each side of the electrolyzer 110. Circulating alkaline solution will fan out within the manifolds 148 so the solution can be distributed evenly around a given segment of the each side of the electrolyzer 110. Since the electrolyzer 110 is spherical and an odd shape, the manifold 148 will wrap a predetermined distance around a small percentage of the electrolyzer circumference. Holes can be placed in the electrolyzer wall 142 at evenly spaced points internal to the manifold space to aid even flow. Again, any exposed electrically conductive material, such as drilled holes of the internal manifold surfaces, require insulation to prevent the possibility for plating and to prevent energizing the electrolyzer walls creating a safety issue.

A flange 150 can be disposed on each electrolyzer hemisphere and, therefore, 360 degrees around the circumference of the electrolyzer 110 allowing for internal access for maintenance and inspection. The electrolyzer shell 142 can split open allowing access and entry into the shell interior. Rings, which can be disposed in two rows, can provide structural integrity and sealing to support 600 psia or more of internal pressure. The flange 150 can have recesses to support seals that will run 360 degrees around the flange 150. Nuts and bolts, clamps, or other means passing through holes cut into the flange 150 can hold the two hemispheres together while the electrolyzer 110 is under pressure during normal operation.

Along with the internal membranes 136, a main membrane 152 will allow electrical current flow through the membrane 152 but will not allow gas bubbles to pass. The main membrane 152 is located in the direct electrical current path between the anode and cathode but will not be electrically conductive. A flange 150 passing through the center of the electrolyzer 110 will structurally support the main membrane 152 and will be insulated to further prevent electrical current flow and help channel alkaline solution circulation through the electrolyzer 110.

The electrolyzer 110 can retain an alkaline solution 154 of Potassium Hydroxide (KOH), Sodium Hydroxide (NaOH), or some other hydroxyl group catalyst that supports electrical conductivity but does not breakdown during water electrolyses. Approximately 25% by weight or more will assure strong conductivity. Also, super saturating the solution 154 can minimize gas absorption by becoming part of the water-hydroxyl solution at high operating pressures. As another safety precaution, relief valves 156 installed at the top of the cylinder sections of the electrolyzer 110 will prevent pressure run-away. Discharges can be piped to the open atmosphere, exterior to building structures.

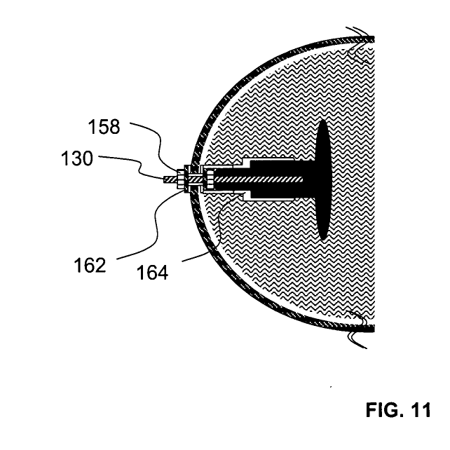

The electrolyzer conductor securing system is detailed in FIG. 11. The objective is to achieve structural support for the graphite anode or cathode conductors 128A or 128B along with sealing the access ports to contain the internal pressure of the electrolyzer 110. Interior and exterior nuts 158, which can be stainless steel, secure and seal the anode or cathode conductors 128 to the vessel wall 142. A threaded conductor 130, which again can be stainless steel, extends well past the stainless steel nuts 158 so that a supply bus can be secured to it. Flat, locking, and insulated washers 162 will prevent damage to the vessel wall 142, seal the assembly, and prevent energizing the vessel wall 142 and lock the nuts 158 preventing back off due to vibration during electrolysis. Insulation 132 will prevent the vessel skin from getting energized. Shrink wrapped around the graphite conductor 128 and tucked between the insulated washers 162 will create a watertight seal that will prevent water exposure to the stainless steel threaded conductor 130.

Referring again to FIG. 9, the electrolysis system 10 contains two receivers that allow alkaline solution and gas to pass from the electrolyzer 110 and enter a space where gas can be separated from liquid. To accomplish the alkaline solution circulating through the electrolysis system 10, a low speed, near laminar flow is created. Alkaline solution and gas flowing into the accumulators 112 and 114 will slow in rate due to the open space of the vessel compared to the supply line, which will promote bubbling and separation between gas and liquid. Membranes present in the direct flow path will further promote the collection of gas bubbles that will increase in size until buoyancy overcomes surface resistance and bubbling occurs. Multiple membranes can be added to the accumulator system to trap fine bubbles that may pass through the first membrane. Experimentation will determine the quantity and porosity required to trap bubbles without significantly resisting flow.

As bubbles collect at the top of the receiver, gas displaces the solution and a level will form. As gas continues to form, the internal system pressure will rise. The gas bleed-off control system will tell the bleed valves supplying the bleed lines 122 and 124 when to open and to bleed off gas at a constant pressure. Level sensors will control the water feed pump to maintain a constant water level as new gas is formed and bled out of the system.

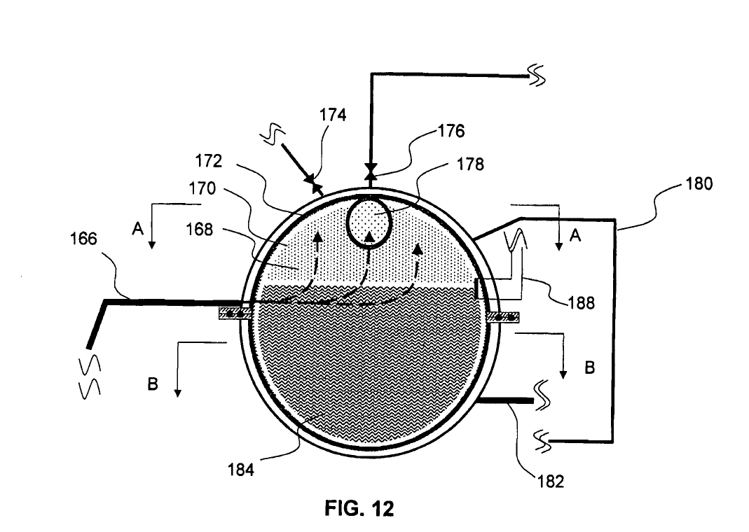

FIG. 12 depicts the internal details of the accumulators in relation to a hydrogen accumulator 112. A mixture of alkaline solution and hydrogen or oxygen gas will enter into the accumulators 112 and 114 through an circulating line intake 166 under approximately the same pressure as the internal electrolyzer pressure. The mixture will consist of fine and medium sized bubbles that will enter and begin rising to the top of the accumulator 112 and 114 to begin the separation process. The upper third of the accumulators 112 and 114 will consist of a hydrogen or oxygen gas volume 168. The gas volume 168 will contain alkaline solution mist from the bubbling of the gas. The mist will be separated from the gases in the dry pipe 178.

As in the electrolyzer 110, the accumulators 112 and 114 will be insulated with internal insulation 170 to avoid potential safety hazards of energizing the accumulator shell 172 and to eliminate to possibility of creating a conductive path in any location other than the anodes and cathodes. The accumulator shell 172 can be made of stainless steel or another high tensile strength material such as carbon fibers to withstand the pressures and temperatures of electrolysis, which can be over 200 psi and 220 F and higher. The accumulators 112 and 114 and the electrolyzer 110 can have relief valves 174 as a safety precaution to protect the system and personnel from the dangers of system run away should there be a malfunction in the system pressure controls. A bleed valve will enable each accumulator 112 and 114 to bleed-off hydrogen or oxygen at a steady pressure avoiding cycling. An internal pressure sensor will communicate to a controller that will regulate the bleed valve 176 to maintain a steady pressure internal to the accumulators 112 and 114.

The dry pipe 178 can be constructed of the same material as the membranes and will separate alkaline solution particles from the hydrogen or oxygen gas prior to being bled-off from the accumulators 112 and 114. Additional accumulators/dryers may be added in-line to the gas storage containers to eliminate any additional traces of alkaline solution that may exist in the supply gas.

As hydrogen or oxygen gas is produced, water is consumed in the electrolysis process and has to be replaced. A purified water feed 180 can be provided into the accumulators 112 and 114 so that it can mix with the water/hydroxide solution to maintain conductivity the electrolyzer 110. The feed water, pressurized slightly above the accumulator internal pressure, can create a flow. As hydrogen and oxygen are separated out of solution, the hydroxide salt remains in solution. As new water is added, the percent solution remains constant. Once alkaline solution passes through the membranes and gas bubbles are removed, the remaining solution will be re-circulated through a recirculation mechanism 182 back into the electrolyzer 110 for reprocessing.

Due to the flow path created in the accumulator design, alkaline solution 184 must pass through the membranes prior to re-circulation. The section is a temporary collection area prior to re-circulation. The hydroxide component is added to purified water to create a conductive path that is fundamental for electrolysis. Approximately 25% by weight to saturation will be added into the purified water volume taking up the entire electrolysis system. The percentage by weight will be slightly lower in the re-circulation alkaline solution due to the addition of purified water at this point. The solution percentages will rise in the electrolyzer 110 where purified water is removed from the system increasing the solution percentage by weight.

Porous membranes 186, which may be non-electrically conductive, allow water to pass freely, and will not allow gas bubbles to pass through. All membranes 186 in the electrolyzer 110, accumulators 112 and 114, and dry pipes 178 can be made of the same or different materials but will meet the criteria mentioned above. FIGS. 12B and 12C show cross-sections A-A and B-B to further detail the positioning of the membranes 186. The illustrations are mere examples; actual applications may have additional or fewer membranes.

A potentiometer 188 can measure the water level to a tight range. The potentiometer 188 will send a fine resolution signal to a Programmable Logic Controller or similar means that will control the volume of gasses exiting the electrolyzer 110 thus controlling the water level. Water will be maintained at a constant level in both accumulators 112 and 114 to maintain a steady pressure balance between the two sides. A pressure balance assures minimal cross flow through the main membrane 186 in the electrolyzer 110 minimizing the possibility of cross contamination of the production gases.

An alternate dynamic electrolyzer cell is contemplated. The amount of current flowing from the anode 128A to the cathode 128B will be a function of the line voltage and the resistance present in the water directly between the anode 128A and cathodes 128B. Resistance can be reduced by increasing the hydroxide solution concentration and, additionally or alternatively, closing the gap between the anode 128A and cathode 128B thereby reducing the distance that current has to travel through the alkaline solution. In addition, resistance can be reduced by maximizing the surface area of the anode and cathode faces, such as by dimensionally increasing the length and width or changing the surface texture. An irregular surface, such as a knurled surface, will increase surface area compared to a smooth flat surface thus increasing current flow. The higher the current flow, the more gas will be produced from a given applied voltage. An ideal or substantially ideal point can be approximated by exploiting all possible improvements to percent solution concentration, distance between the conductors, surface face dimensions, and surface texture maximize. To increase gas output further for a given applied voltage, the number of anodes and cathode groups could be increased.

Simply adding an anode and cathode group within the same electrolyzer shell 142 can double the amount of gas production assuming no voltage drop. A multiplicity of groups can be added to an electrolyzer 110 until a diminishing return is reached. For example, again assuming no voltage drop, adding a group can be assumed to double current draw and double output. Adding a third will increase out by only a third, a fourth group will increase output by a quarter, and so on until the cost of adding groups outweighs the percent increase in load on the system.

With further reference to FIG. 10, alkaline solution is forced through the groups to continually remove gas bubbles forming in the anode and cathode groups to minimize the potential for cross contamination across the membrane separating the anodes and cathodes. A membrane 152 still resides between the anode and cathodes 128A and 128B allowing electricity but not electrolysis gases to flow between the conductors. A non-porous baffle separates the cell groups channeling alkaline solution being pumped through the system to flow directly from the bottom to the top of the electrolyzer 110 and to be evenly distributed between the cell groups. As indicated earlier, manifolds on the top and bottom and on both sides of the electrolyzer 110 distribute alkaline solution evenly to the cell groups as it enters into the electrolyzer 110.

The mounting support assemblies for the anodes and cathodes 128A and 128B are 90 degrees offset from FIG. 10. Rather, the support structures are in the same plane as the anode and cathode faces. Although the mounting and insulation system are similar as shown in FIGS. 10 and 11 (illustrating the mounting system to be 90 degrees to the anode and cathode faces), this alternate cell design results in the mounting system being inline with the anode and cathode faces. An optional second support on the opposite side of the electrode may provide extra stability for both anodes and cathodes. In-line supports allows for thin and flat anode and cathode plates with large surface areas. The large flat face of both anode and cathodes face each other, allowing a closer distance than a non-flat electrode. Also, steady linear alkaline solution flow though the groups and increasing the flow rate further reduces the risk of “gas clouding” because gas bubbles are immediately removed from the space between the anodes and cathodes thus allowing an even closer distance between each anode and cathode within a group. The final baffle on the most outside group on both sides of the electrolyzer can be porous to allow the inner pressures within the electrolyzer to equalize and to impose an even pressure around the entire electrolyzer sphere.

In an actual application, the addition of groups will create an increased load on a generator. This load can induce an increase in back EMF in the generator, which can begin to generate internal heat within the coil windings. With an increase in heat, the internal resistance within the windings increases inhibiting current flow until an equilibrium is reached. As additional groups are added, the load on the generator will continue to rise causing a larger back EMF increasing torque on the prime mover and generating even more heat internal to the coil winds further increasing internal resistance until a new equilibrium is found. At some point, a maximum load is reached where exceeding this load can cause prime mover to stall or the generator to burn out through damage to the coil winding insulation within the generators due to excess internal heat created by the current load on the system. The number of groups or size of the cell bank will require careful calculation to determine the maximum allowable cell bank size that can be applied to a given generator size. Too small a cell will result in inefficiencies, too large a cell may damage the generator and/or stall the prime mover.

In addition, the prime mover that harvests energy, such as through wind or wave, will vary in its output depending on atmospheric conditions at any given time. As a result, prime mover stalling may be more likely during low activity periods. Controlling the amount of cell bank groups in operation at any given time will control the amount of back EMF being applied to the prime mover. Cutting cell bank groups in and out may be needed to adjust prime mover load under different sea, wind, or other conditions. Low activity may require fewer groups in operation as compared to high activity periods, which would require more groups engaged to maximize efficiency. Finally, wire gage chosen for the supply generator will be important to minimizing internal resistance thus controlling heat and reducing potential damage to the winding insulation.

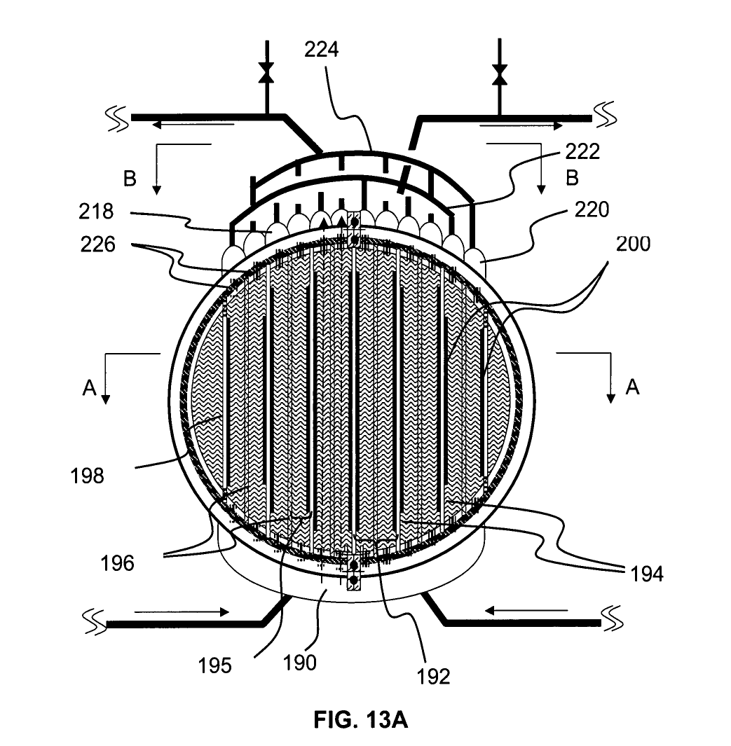

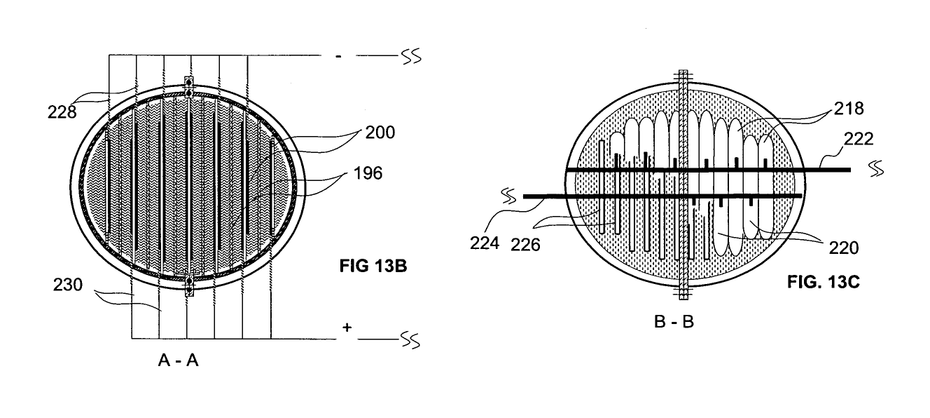

FIGS. 13A and 13B depict an alternative electrolyzer cell grouping. Since alkaline solution being recycled back in to the electrolyzer 110 will be free of gas bubbles, an intake manifold 190 is provided that is open to both sides of the anode and cathode groups and to each group, distributing alkaline solution evenly to each group at a steady rate. A cell group 192 includes an anode and cathode plus a membrane 196 between the two sides. The cell group 192 channels alkaline solution between a right and left baffle 198 allowing solution to travel in a linear path over and around the conductors while hydrogen and oxygen is generated by electrolysis.

Slits 201 in the electrolyzer shell 142 at the bottom and top of each side of each group 192 allow alkaline solution to enter, pass over the conductors 200, and exit the channel in a linear fashion. Alkaline solution in one group moves independently from other groups. Also, alkaline solution independently transfers hydrogen and oxygen bubbles through each group on each side of the membranes 196 keeping the dissimilar gases away from each other until they exit the electrolyzer 110. Forcing alkaline solution through the group channels will, as indicated earlier, contribute to preventing cross contamination of gasses across the membrane and to improving system safety.

Non-porous, electrically insulated baffles 194 stretch the entire length of the diameter of the electrolyzer shell creating a channel for alkaline solution to flow independently in a linear path through each group. The group baffles 194 make up the borders of each group 192 within the cell, each of which contains both an anode and cathode side. The membranes 196 allow electrical current to pass through but do not allow gas bubbles to pass. A membrane 196 will exist per group and will cover the entire diameter of the electrolyzer shell 142.

Outer baffles 198 on the outermost groups to the right and left side will be mostly non-porous but will contain vent holes allow enough alkaline solution to enter to equalize the pressure within the entire electrolyzer 110 to assure uniform solution concentrations throughout the electrolyzer 110. The anodes and cathodes 200 can be made of graphite or another material that will not plate during electrolysis.

Conductors require uniform support. Conductor plates are screwed or glued to the group baffles by an adhesive sufficient to support the weight of the plates without cracking. The anodes and cathodes 200 can be cut in standard sizes so that both anodes and cathodes 200 are approximately equivalent dimensionally. Each group may be sized differently to maximize surface area given the group's location within the electrolyzer shell 142. The larger the surface area, the greater the current flow between the conductors 200. In addition, the anode and cathode faces are irregular to maximize surface area for a given dimension.

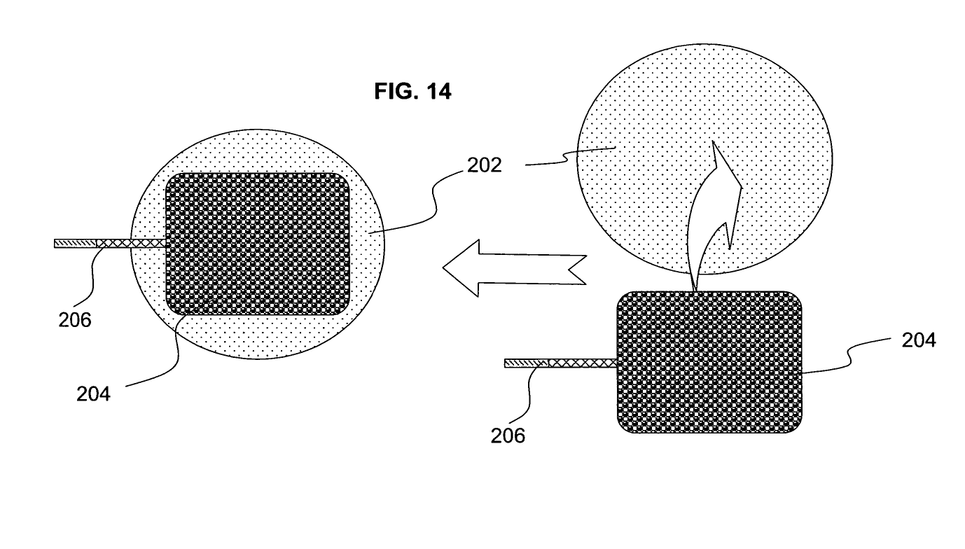

FIG. 14 illustrates a conductor and baffle assembly. A baffle 202 covers the entire cross sectional area of the electrolyzer interior. Whether the electrolyzer shell is constructed as a sphere or elongated tank, the baffle 202 seals the entire inner diameter. The baffle 202 is electrically insulated to prevent plating during electrolysis. A conductor 204, which can be made of graphite, carbon fibers, or another effective material, can comprise a flat, electrically conductive plate that will not plate during electrolysis. One side is anchored to the baffle 202 and the other side is exposed to the electrolyte and faces the opposite conductor 204 on the opposing baffle 202. A conductor wire 206 is insulated from the electrolyte but completes a conductive path to the conductor 204. The other end of the conductor 204 passes through the electrolyzer shell and connects to the power supply bus.

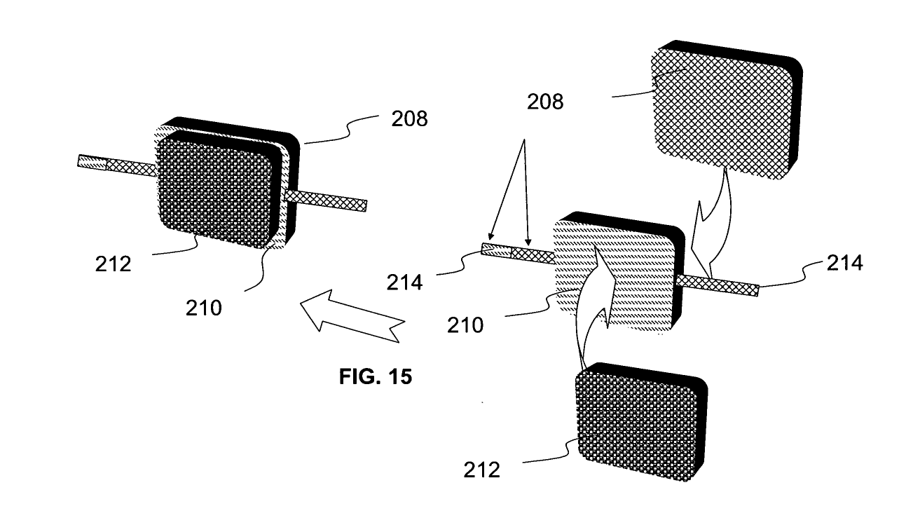

FIG. 15 illustrates an alternate conductor assembly. An insulated backing 208 covers one side of the conductor plate allowing current flow in one direction. A conductive mounting bracket 210 supports the weight of the conductor and provides a path for direct current to pass to the graphite conductor 212, which anchors to the mounting bracket 210. The surface can be irregular to maximize surface area. Partially insulated metal rods 214 support the weight of the assembly on both sides and provides a conductive path for direct current. The ends of the rods 214 penetrate the electrolyzer shell and connect to the power supply bus. The entire assembly is coated on one side by the insulation backing 216. Direct current flows in through the conductor rods 214, throughout the mounting bracket 210, and into the graphite conductor 212. The irregular surface of the graphite conductor 212 faces out toward the opposing conductor 212to maximize surface area to improve electrolysis efficiencies.

On the hydrogen side of each group, alkaline solution and hydrogen bubbles need to be removed from the electrolyzer and transferred to the accumulators. Manifolds 218 dedicated to the hydrogen side of each group will collect the mixture through slits 226 cut into the electrolyzer shell. Each manifold 218 can be connected through a piping inter connection system 222 and transferred to the accumulator through a main line as shown in FIGS. 13A and B. Oxygen manifolds 220 carry out the same function for the oxygen side of each group. Each manifold 220 pipes into a common line, which transfers the oxygen/alkaline solution to the oxygen manifold 220.

Each group has two sides: hydrogen and oxygen. Each side has a heavy concentration of hydrogen or oxygen bubbles that due alkaline solution being forced through the electrolyzer 110 will flow briskly out of the electrolyzer 110 and into the accumulators 112 and 114. The flow will minimize bubble residence time between the conductors 212 and the membranes to provide further assurance of little to no cross contamination. A hydrogen pipe network 222 will collect hydrogen rich alkaline solution from each group and funnel it to a common accumulator feed line, and an oxygen pip network 224 will collect oxygen rich alkaline solution from each group and funnel it to a common accumulator feed line.

A slit 226 is cut into the electrolyzer shell over and under each group side. The slits 226 are cut approximately a 30-degree arch along the shell circumference. The slits 226 allow independent but even water flow through each side in each group. Where the electrolyzer 110 is a pressure vessel, each slit 226 will require more material thickness 360 degrees around the slit 226 to support shear stresses on the electrolyzer shell.

Conductor leads 228 for the anode and cathode allow an electrical path through the electrolyzer 110. The electrolyze shell is insulated from the leads 228 and the portion of the leads 228 that are in contact with the alkaline solution will be electrically insulated. The lead 228 will screw into the side of the anode or cathodes and then by sealed with insulating material to prevent the possibility of plating of any portion of the leads 228 during electrolysis. The portions of the leads 228 connected to the generator bus have insulation surrounding the connection for safety purposes. Finally, positive and negative bus wires 230 deliver direct current to the electrolyzer conductors. Each conductor can be wired in a parallel circuit evenly distributing power to each cell group.

The invention can alternatively be carried forth employing static high pressure electrolysis. Although recycling alkaline solution through an electrolyzer 110 will minimize the chances of cross contamination, energy is consumed in circulating the alkaline solution. A static approach is more efficient due to the absence of circulating pumps. By facing the anode and cathode toward one another and installing a dense membrane with a fine porosity, segregation between the two sides can be assured. As mentioned in above in relation to a dynamic electrolyzer cell, adding multiple cell groups will maximize the current load on the generator making the prime mover the critical factor for determining total hydrogen and oxygen production.

Multiple groups wired in parallel assure the electrolyzer 110 can draw most of the energy load harvested by the prime mover. Most of the components are very similar to the dynamic version with some modifications. In addition, as mentioned in relation to the dynamic version above, heat generated from electrolysis is a concern. Most of the heat will be drawn away with the production gases. Some residual heat may exist. Circulating alkaline solution through radiators extracted from the accumulators can be employed to control excess heat that cannot be removed by production gases. Heat can also be controlled by minimizing the resistance in the water between the anode and cathodes.

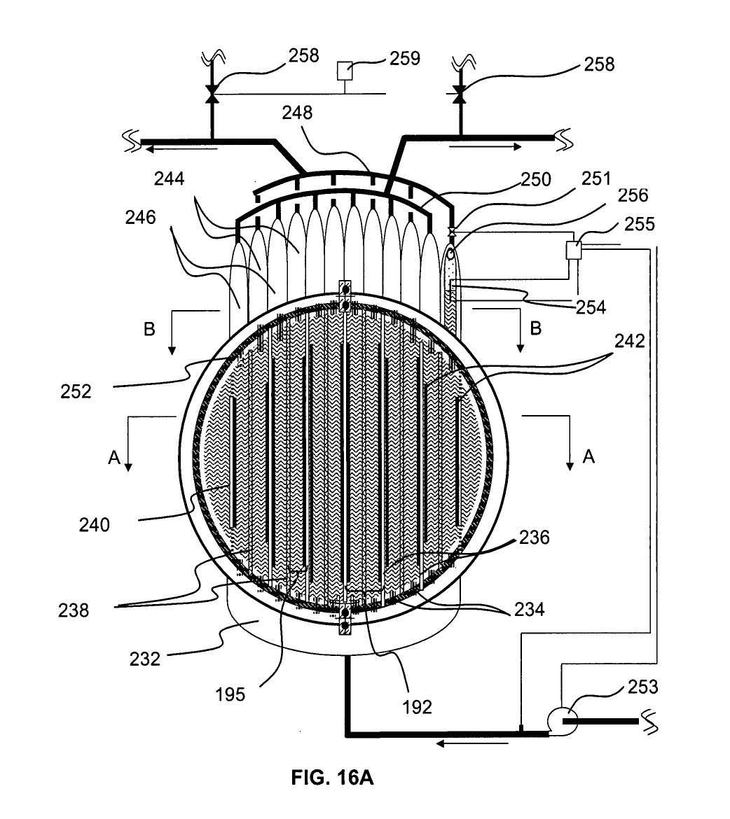

A static electrolyzer cell can be better understood with reference to FIG. 16A-16C. Purified water can be introduced into the electrolyzer 110 alkaline free and distributed evenly to each group at a steady rate. The hydrogen side of each group should to draw more water than the oxygen side. Level sensors located in the hydrogen and oxygen manifolds 232, which can sit atop the electrolyzer shell, can communicate to a PLC controller to throttle the gas bleed valves, which can be above the manifolds, to control the water level in the manifolds. Where the feed pump will supply a constant head pressure to the shell, the intake manifold 232 will distribute the pressure evenly between the sides while feeding water volume unevenly between the two sides of each group.

Consisting of both anode and cathode 242 plus a membrane 238 between the two sides, the cell group 234 channels alkaline solution between a right and left baffle allowing gas bubbles to travel in a linear path over and around the conductors. Openings in the electrolyzer shell at the bottom and top of each side of each group can allow purified water to enter the electrolyzer 110 and mix with the alkaline within the unit to provide make-up water as hydrogen and oxygen production consume water already present in the electrolyzer. Each group/side operates independently from the other, but pressure within the electrolyzer 110 distributes evenly across the groups. Hydrogen and oxygen bubbles are generated independently through each group on each side of the membranes 238 thereby tending to keep the dissimilar gases away from each other until they exit the electrolyzer 110. The membrane 238 placed in the center of the group prevents cross-contamination of the gasses.

Non-porous, electrically insulated baffles 236 stretch the entire length of the diameter of the electrolyzer shell creating a channel for water to flow independently of each side within each group. Baffles 236 make up the borders of each group within the cell, each of which contains both an anode and cathode side. The group membranes 238 allow electrical current to pass between the anodes and cathodes 242 but do not allow gas bubbles to pass. Where cross contamination is unlikely, an open intake manifold 232 may be sufficient to feed the electrolyzer 110 with purified water.

Porosity should be less than 5 microns. Independently controlled purified water valves or pumps are needed to control the flow of water separately into each side of each group thereby preventing pressure imbalances and forcing alkaline from passing across the porous membranes 238 as one side consumes more water than the other creating an opportunity for pressure differentials across the membranes 238. In this case, feed water volume control for each side is important to assure make up water replaces electrolyte as it is consumed from each side, assuring a zero pressure differential across the membranes 238. The secondary prevention of cross contamination is the membrane 238 itself. A low porosity will trap gas bubbles preventing cross flow of bubbles should cross-alkaline flow occur from time to time.

The group baffles 240 on the outermost groups to the right and left side can be mostly non-porous but will contain vent holes to allow enough alkaline solution to enter to equalize the pressure within the entire electrolyzer 110 assuring uniform solution pressures throughout the electrolyzer 110. The anode and cathodes 242 can be made of graphite, carbon fiber, or equivalent materials that will not plate during electrolysis. The conductors require uniform support to prevent cracking or pealing. Conductor plates are screwed or glued to the group baffles by an adhesive, mechanical fasteners, or other means sufficient to support the weight of the plates as one can perceive from FIG. 14. The anode and cathodes 242 can be cut in standard sizes for the right and left so that both anodes and cathodes 242 can be approximately equivalent dimensionally. Each group may be sized differently to maximize the surface area given the group's location within the electrolyzer shell. Again, the larger the surface area, the greater the current flow between the conductors. In addition, the anode and cathode faces can be irregular to maximize surface area.

On the hydrogen side of each group, hydrogen bubbles need to be removed from the electrolyzer 110 and transferred to the storage tanks. Accumulators 244 dedicated to the hydrogen side of each group can be employed to collect a mixture of hydrogen gas and alkaline solution, to allow hydrogen to bubble out of the water creating a hydrogen gas pocket, and allow gas to bleed out of the manifold 232 through a dry pipe 256. The gas and water mixture passes through the electrolyzer shell through slits, holes or other openings 252 cut into the electrolyzer shell. Each accumulator 244 will be connected to each other through a piping interconnection system 10 and to the gas storage container through a main line as in FIG. 16A. The accumulators 244 and electrolyzer shell openings 252 can be shaped in an elongated configuration as illustrated in FIG. 16B. Alternatively, they can be completely round or any other effective shape. Shell openings 252 may be offset or sufficiently separated to ensure structural integrity of the shell. As with the hydrogen accumulators 244, the oxygen accumulators 246 carry out the same function for the oxygen side of each group. Accumulators 246 pipe to a common line to transfer oxygen to the oxygen storage tank.

Each group has two sides, hydrogen and oxygen. Each side has a heavy concentration of hydrogen or oxygen bubbles that flow briskly up and out of the electrolyzer and into the respective accumulator. Bubbles travel vertically due to the lack of turbulence in the electrolyzer 110 and the presence of both the membranes 238 and baffles 240 channeling gasses to the top of the electrolyzer 110 and into the accumulators 244 and 246. The hydrogen pipe network 248 will collect hydrogen from each accumulator and funnel it to a common storage tank feed-line, and the oxygen pipe network 250 will collect oxygen from each group and funnel it to a common storage tank feed-line.

The openings 252 can allow independent but even gas flow through each side and into each accumulator 244 and 246. Where the electrolyzer 110 is a pressure vessel, each opening will require more material thickness 360 degrees around the opening 12 to support shear stresses on the electrolyzer shell. The opening 252 can be a slit, a round hole, or any other effective shape to facilitate structural integrity, cost control, and general function of the electrolyzer system.

Sensors 254 in each accumulator 244 and 246 provide feedback for a control system, such as a programmable logic controller as to the height of the water line within the accumulator 244 and 246. The controller can adjust the bleed valves at the top of the accumulators 244 and 246 to maintain a steady water level regardless of the gas production rate.

It will be noted that, although the accumulators 244 and 246 separate gas from water, the gas may have small traces of water vapor in it as it bubbles out of the water. A dry pipe 256 can be made of fine porous material that allows gas to pass through but prevents water from passing thus “drying” the gas prior to entering the gas pipe network 248 or 250. Safety valves 258 can prevent excessive pressure if the pressure controllers or valves fail. To prevent damage to the membranes internal to the electrolyzer 110, safety valve activity can be sensed by a controller that will open the other safety valve 258 if one opens. If both safety valves 258 open at the same time, the internal pressure differentials between the right and left sides of all groups remain zero. Therefore, the membranes 238 will not be damaged. If only one safety valve 258 opens, a large pressure differential will exist between the sides and the membranes could blow out. Therefore, the controller is necessary to prevent damage should the safety valve 258 open.

Anode and cathode conductor leads 260 allow an electrical path through the electrolyzer 11 O. The electrolyzer shell can be insulated from the leads 260, and the portion of the leads 260 that are in contact with the alkaline solution can be electrically insulated. The leads 260 can screw into the side of the anode or cathodes 242 and then be sealed with insulating material to prevent the possibility of plating of any portion of the leads 260 during electrolysis. The portions of the leads 260 connected to the generator bus can have insulation surrounding the connection for safety purposes. Positive and negative bus wires 262 deliver direct current to the electrolyzer conductors. Each conductor can be wired in a parallel circuit to distribute current evenly to each cell group.

It will again be noted that work can be harvested through mechanical decompression of hydrogen and oxygen. Due to the higher specific weight and the thermodynamic properties of oxygen, more work will be converted by oxygen than hydrogen during decompression. A reciprocating or rotary decompression system can be used. A reciprocating system can provide a more efficient decompression over a rotary concept since almost half of the available energy can be lost in a turbine approach. Accordingly, a reciprocating concept will be the area of focus for decompression herein.

Temperatures within the decompressors 28 and 40 as shown in FIG. 1 are expected to cover a wide range. Intake temperature is expected to be between 150 to 300 degrees Fahrenheit and higher if additional compression steps are added. Exit temperature is expected to be −80 to −160 degrees Fahrenheit. In addition, to control foreign material contamination, an oil free system can be incorporated. Near frictionless materials, such as Teflon or the like, can be designed into the bearing surfaces to make a very clean decompression system. In addition, due to the temperature differentials within the decompresser, lubricants will likely be ineffective at very low temperature further justifying the need for low friction surfaces.

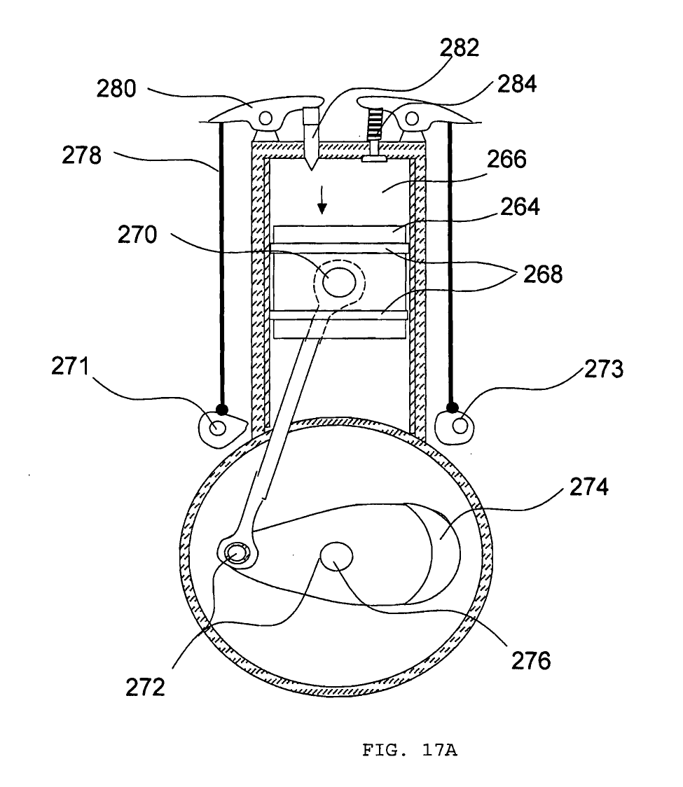

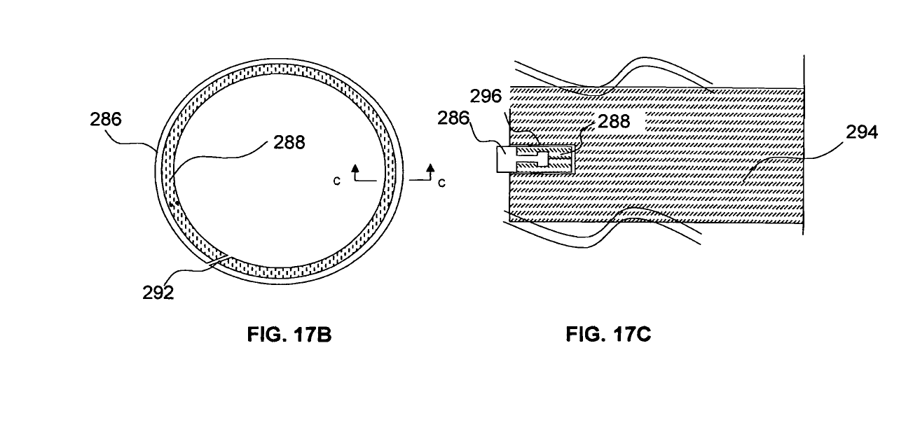

FIGS. 17A, 17B, and 17C depict a decompressor 28 as disclosed herein. Although a cam system is illustrated to open and close valves, numerous other systems, such as solenoid arrangements, are possible and within the scope of the invention. A major feature of this prime mover is the conversion of potential energy in a compressed gas into rotating/mechanical work by isentropic decompression. A piston 264 can be made of materials that will not chemically interact with hydrogen and oxygen. For example, stainless steel, aluminum and carbon fiber/polymer resin laminate are viable materials for this application. The piston diameter calculation will be a function of the cubic inches needed to expand the expected gas flow rate for the system. The flow rate will be dependent upon demand from the internal combustion or other engine 34.

Low friction material, such as Teflon or the like, that will not react with hydrogen can be employed in a cylinder liner 266. Teflon can also be considered advantageous in that it has a very wide operating temperature where it will remain stable. Liquid lubricants will function well at 200 to 300 degrees F. but will not function well at −100 to −160 F. Solid lubricants will function at low temperatures but will tend to contaminate the engine 34 and will carry into the closed loop system. Teflon or equivalent material will lubricate the engine 34 while tolerating the required temperature ranges without contaminating the system.

Like the liner 266, low friction rings 268, which again can be formed with Teflon or the like, can provide a near frictionless bearing surface that will tolerate the operating temperatures of the system without creating contamination. In addition, Teflon has structural stability that can hold up to the forces imposed in the decompression process. Rings 268 cut to sufficient dimensions will create rigidity to take the forces imposed on the rings 268. Where a 100% Teflon ring does not have the same elasticity as a carbon steel ring, the normal slit cut ring may prevent a sufficient ring seal against the cylinder sleeves during the expansion step.

An alternative ring design is an aluminum or stainless steel inner ring with a low friction material outer ring. The inner ring will provide sufficient elasticity to allow a slit to be cut into the ring allowing spring action to sufficiently seal internal pressures between the cylinder walls and the piston preventing blow-by. Teflon on the outer ring can create a near frictionless surface with the cylinder sleeve with low friction material, such as Teflon, in contact with low friction material, such as Teflon.
a. FIG. 17B depicts the metal/Teflon ring assembly with an outer ring 286, which can be of Teflon, that creates the bearing surface to the cylinder sleeve. The inner diameter of the outer ring 286 can be machined in a “T” shape to create an anchor. Where a low friction material is employed, a mechanical interference anchoring system can secure the outer ring 286 to the inner ring 288. The inner ring 288 can be in two mirror pieces made of aluminum, stainless steel, or other appropriate material. A negative impression of the “T” anchor can be machined into both sides of the inner ring 288. The two sides place around the “T” anchor such that the “T” anchor sets into the recesses and is sandwiched between to two sides of the inner ring 288.
b. The inner ring 288 can be screwed together by set screws 290 or other means as illustrated. The anchor and inner ring recesses should have an interference fit so that, when the sides are screwed together, they create a press fit around the Teflon “T” anchor. The screws 290 are spot welded in place once set to prevent “back off” due to vibration during operation.
c. Where the inner ring 288 will provide elasticity to the ring assembly, a “ring slit” 292 cut into the entire ring assembly can provide constant ring pressure against the cylinder sleeves thereby sealing the high-pressure side of the cylinder from the low-pressure side. The overall diameter of the ring 288 can flex in and out as the cylinder temperature changes from warm at top dead center to cold at bottom dead center where the cylinder diameter is larger at the bottom than at the top due to temperature differentials. To offset this, a shallow taper machined into the cylinder walls can be employed to minimize the effect of these temperature differentials.
d. The piston and walls 294 will be made of a material that will not chemically interact with hydrogen or oxygen. The piston walls 294 can have recesses machined into them to secure the piston rings. Two or more rings per piston should provide an adequate seal. The more rings, the more sealing potential. Although the rings are low friction, energy losses will occur through the rings. Therefore, a balance between creating a positive seal and avoiding unnecessary friction is important.
e. Where the rings 286 and 288 will flex and vibrate within the ring channels during operation, wear may occur between the inner rings 288 and the channels. Teflon recess rings 296 placed inside of the piston channels will provide the needed lubrication for the rings 286 and 288. The recess rings 296 will also have a slit so that the ring can be placed around the piston walls 294 during installation. The recess ring 296 will float during operation and can be held in place by the compression rings themselves. The cylinder diameter limits ring expansion.

Looking again to FIG. 17A, low friction bearings 270 and 272 of Teflon or the like used for bearing surfaces to secure the piston rod to the piston and the piston rod to the crank thus avoiding having to use lubricants. Cams will time the injection of gas into the cylinders and time exhaust valve operation to allow gasses to exit the cylinder. High pressure intake gasses inject at or a little past top dead center. High pressure intake gasses will power the piston 264 in the down stroke. The cams will be geared or chain driven to the crank shaft 276 using known means. Lubricants may be used on the cam where there will not be any contact with the internal gasses within the cylinder. However, utilizing low friction bearings for the cam and push rod riders is ideal and will be the priority concept. An alternate approach to cam timing is the use of solenoids to push open valves. The timing of solenoid actuation can be controlled by actuation contacts or markers around the circumference of the drive shaft. The key is to close an electrical circuit at the correct time and duration to assure the operation described above. Actuation contacts or markers fixed on the drive shaft can accomplish that task.

The cam system for the exhaust side will be engineered using the same concept as conceived for the injection side. The cam timing will allow for a long valve opening time for the entire up stroke to exhaust the working gas at a low pressure, such as near atmospheric, and low temperature −100 to −160 degrees F. through the cam system exhaust 273. The same alternate solenoid concept also applies for the exhaust side of the engine 34. A counterweight 274 stores energy from the down stroke and pushes the piston 264 up on the upstroke. It also evens out the internal forces of the reciprocating action to smooth engine operation. A crank can rotate around the crankshaft 276 creating rotary motion. The crankshaft 276 transfers the rotary motion and work from the decompressor through the internal combustion engine 34 and into the drive shaft. A push rod 278 can push open the injector or exhaust valve at the desired time of the piston stroke. The riders on the push rods 278 should have near frictionless bearings, such as Teflon or equivalent, to avoid the need for lubricants in the system. Rocker arms 280 can transfer upward motion to downward motion to open cylinder injectors or exhaust valves.

The decompression engine can run off hydrogen or oxygen or, in fact, any compressed gas. The supply line to the injector 282 is under high pressure, such as above 300 psi. The injector 282 allows a predetermined volume of gas to enter the cylinder and force the piston down creating a power stroke. The injector 282 can be opened by a rocker arm or solenoid pressing on the injector 282 and initiating a charge. Internal springs will quickly close the injector 282 once the rocker arm force is relieved. Once the gas within the cylinder is expanded and the work transferred to the crankshaft 276, excess gas needs to be exhausted from the cylinder so that the cylinder can be prepared to receive the next injection to initiate the next power stroke. The piston 264 forced up by centrifugal force from the counterweight on the crank will begin to move from bottom dead center to the up stroke. At bottom dead center, the discharge valve 284 will open by being forced by a rocker arm 280. The cam or solenoid can be timed to assure a long open period to allow low-pressure gas to be forced out of the piston at a steady pressure during the entire up stroke. When the piston 264 nears top dead center, the exhaust valve 284 will close. At or shortly after top dead center, the injection valve will open starting the power stroke over again.

Thus, the internal combustion engine converts potential energy to kinetic energy in the form or mechanical rotary torque. Hydrogen and Oxygen at approximately atmospheric temperature and pressure can be supplied to the internal combustion intake. Both hydrogen and oxygen will combine in the engine carburetor along with intake air. A sufficient amount of oxygen is provided to burn all of the hydrogen available efficiently. The heat of combustion within the cylinders can be transferred to the air also present in the cylinder under pressure. The heat of combustion will expand the air and create a power down stroke. Warm air and saturated steam will then be exhausted on the up stroke with little to no change in the oxygen content and general composition of the air with the exception of the presence of saturated steam.

Similar to the decompressor construction, the internal combustion engine 34 can be made of materials that will not chemically interact with hydrogen or oxygen. Low friction material, such as Teflon, can be used for the bearing surfaces to avoid or minimize liquid lubricants. As with the decompression process, the internal combustion process can use low friction bearings making the process clean and to minimize oil or carbon contamination in the exhaust gases. The carburetor can include hydrogen and oxygen feeds through the air intake. The volume of hydrogen and oxygen can be metered by control valves on each gas line.

The internal combustion engine 34 can be a two-stroke, four-stroke, rotary, or other type of engine. The number of cylinders, bore, and stroke will be a function of the required power needed in combination with the power output of the decompressor to turn the house generator at sufficient RPM's to satisfy the load and specification requirements of the power distribution system. The internal combustion engine 34 can operate at a constant RPM, but fuel consumption will vary depending upon the load placed on the AC generator. Since the AC line generator may rotate at high speed, such as approximately 3600 rpm's, it is likely that overdrive gearing will be employed for both the internal combustion and decompresser engines to minimize internal stresses and extend operating life.

A line generator 38 as in FIG. 1 can run at standard RPM's, phases, frequencies, voltages, and loads. The generator 38 can run at a constant rate, and power output will be a function of current flow or load on the system. Alterations in load will change back electromotive force (EMF) thus varying fuel demands and ultimately shifting the power output of the internal combustion engine 34 and the decompressors 28 and 40 to overcome changes in back EMF. For example, the larger the load, the greater the back EMF or back torque that the generator 38 will apply to the drive shaft. The greater the back EMF, the greater the fuel demands required by the internal combustion engine to overcome the back EMF thus causing more hydrogen, oxygen, and air to be supplied to the internal combustion engine. More fuel demands will result in higher gas volumes passing through the decompressers supplementing the internal combustion engine counter-torque being applied to the drive shaft to overcome back EMF thus reaching an equilibrium and maintaining a constant RPM rate. The line generator 38 could be an existing generator at a power station or commercial facility with the prime mover and auxiliaries possibly being converted to the hydrogen/oxygen concept or a new line generator 38 installed as part of introducing onsite electrical power generation.

Two thermal exchanges occur at the heat exchangers 32 and 42. First, as hydrogen and oxygen expand in the decompressors 32 and 42, they will become very cold (−100 to −160 F) due to isentropic expansion. Cold hydrogen or oxygen will warm to approximately ambient temperature by absorbing heat from saturated steam, warm air, and warm condensate; exhausting from the internal combustion engine 34 or gas turbine 74. Warming the hydrogen and oxygen contributes to combustion efficiency. If hydrogen and oxygen were to enter the combustion chamber cold, the gases would absorb heat in the combustion chamber requiring more fuel to achieve the same energy output as with warmer fuel. Where air expansion in the combustion chamber requires less fuel per volume of intake air, preheating intake fuel and air becomes a valued efficiency for the system.

In addition, a unique feature of this system 10 is that intake air is heated before being compressed. Conventional super or turbo charger systems compress air and then heat it in the combustion chamber prior to an isentropic expansion converting heat to work. This system can have two heat input steps. Heat is added to ambient pressure air as it passes through the air heat exchanger taking advantage of the temperature differential between ambient air and exhaust gases to recover waste heat. If air were compressed before being passed through the heat exchanger, isentropic compression would increase the temperature of the air to a point where heat transfer between the exhaust gases and intake air would be impossible. Therefore, passing ambient pressure air through the heat exchanger creates an opportunity to recover waste heat resident in the exhaust gases and recycles it back into the combustion chamber for conversion to work thus achieving thermal system efficiencies not typical of conventional systems. Additional heat is added to the warm/pressurized intake air during combustion in preparation for an isentropic expansion. The total work in the expansion step, the isentropic expansion in the prime mover, is a function of new energy, the heat, from combustion along with recycled energy from heat in the fuel, work form isentropic air compression, and heat in the intake air.

The second thermal exchange is that latent heat is removed from saturated steam to condense the steam at the rate that it is being exhausted. Condensate will recycle into the electrolyzer saving the cost of purchasing and purifying new water. For example, if this system relied completely on city water as its main supply to the electrolyzer, added costs of purification would introduce a variable consumable to the financial equation. Additional costs of cleaning and replacing filters, along with the added energy costs of continuous reverse osmosis operation, plus the utility costs of purchasing tap water along with the potential environmental impact of using large quantities of city water would make the system costly to operate. If seawater were the main water supply, no water purchase costs would be incurred, but the costs of frequently cleaning filters, energy costs, and environmental questions due to brine discharge would still exist to some degree.

Recycling substantial portions of system water, such as over 85%, is desired. Operating costs are greatly reduced where both filtration and water purchase costs are minimized. Water quality of the condensate will be very high, pure enough to supply the electrolyzer such that recycled water has a large economic value. Although the system will likely require some make-up water, the low volume proposes little to no environmental impact and eliminates most of the filtration and procurement costs. Transport costs of recycling water over land and sea propose a challenge. The cost of transport should not exceed the cost of 100% water purification. Transport costs can be controlled by limiting the physical distance between energy harvest locations and energy consumption locations. In addition, cost efficient transport vehicles that rely on alternative power drive technologies, such as fuel cells, can be employed.

Due to the thermodynamic properties of oxygen, O₂ will absorb substantially more heat energy than hydrogen for the same volume. To that end, oxygen heat exchanger will do the majority of condensing while the hydrogen heat exchange will remove residual heat in condensate. This system is not limited to this configuration. Hydrogen and oxygen heat exchangers can be used in any combination within the system to absorb waste heat as needed and practical. An important feature of the overall system is that most of the system waste heat be recycled back through the prime movers to convert into work.

The internal pressures within the heat exchangers are low, estimated to be 15 to 30 psi. It is also possible that multiple passes between decompressers and heat exchangers can be included to step pressure and temperature reductions to manage the decompression steps. Proof of concept testing will determine the most efficient approaches regarding number of pressure reduction steps.

Once water is condensed and cooled, it can be recovered for recycling through the electrolyzer. To assure that contaminants from the internal combustion process or from the system components do not remain in the system, condensate filters can be disposed inline. Filters can be standard carbon bed or other types of filters designed to remove chemicals and particulate from the water. A storage container can hold condensate and make-up water until needed for electrolysis. The water level will fluctuate depending upon demand form the electrolyzer and demand of the prime movers for the line generator.

Make-up water can come from external sources, such as from tap water lines drawn from reservoirs or from seawater. In any case, supply water requires purification to satisfy the water purity specifications for the electrolyzer. Standard reverse osmosis can be employed for water purification. Obviously, a shorter filter life will be experienced for seawater desalinization than for tap water purification. Implementing a back-flushing system in the RO filtration system can extend the life of the filters and reduce the cost of replacement filters.

Reverse osmosis requires significant energy demands due to the high pressures needed to force water through the fine filters and energy waste. The typical efficiency is approximately 45%. Waste energy pumps can be installed to recycle energy to improve RO efficiencies. Typical efficiencies utilizing waste energy pumps can improve efficiencies, such as to more than 85%. Recycling condensate will greatly reduce total system waste energy demands by minimizing the required make-up water.

The economics of recycling water is a function of the cost of transport and environmental impact. For example, if the hydrogen and oxygen generation were very remote from the point of use, the cost of shipping recycled water from the point of use to the point of generation may be high. In that case, one hundred percent reverse osmosis purification may be more economically attractive. The closer the point of generation is to the point of use, recycling becomes more attractive. The economics and environmental requirements for a given region will affect whether recycling is practical. The system has design flexibility to customize to economic and environmental requirements of a given location and scenario.

It is well know in fluid mechanics that water is not compressible. Water, however, can be pressurized by a positive displacement pump while utilizing little energy compared to compressing a gas. In addition, since compression does not occur, there is no increase in heat as a result of pressurization. The main advantage of pressurizing water is to perform electrolysis under pressure, which will produce hydrogen and oxygen already under pressure consuming additional energy such as with isentropic gas compression or incurring friction losses typical of compressors. Therefore, hydrogen and oxygen can be transferred into storage containers avoiding the energy costs of compression. The higher the electrolyzer pressure, the more gas can be stored within a given storage container. Where water molecules are not compressed, electrical resistance within the pressurized electrolyzer will be approximately the same as an electrolyzer that operates at ambient pressure. Post electrolyzer, gases can still be pressurized if they need to be transported over long distances to minimize the trips back and forth and to minimize corresponding costs. The work/heat of compression will be stored in the gases by insulating the gas containers.

The system can function in at least two different scenarios. A first scenario is harvesting and consuming energy at the same location, such as at a wind farm. Where standard wind farms convert wind energy directly into electrical power requirements of the power grid, narrow operating ranges are dictated. Narrow operating speeds require system cut-in and cut-out rates causing turbine blades to feather in high wind conditions and generators to cut out during low wind conditions.

Therefore, traditional systems do not take advantage of wind speed extremes. This system is separated from the power grid. This system will convert wind energy into a fuel and store that energy as potential energy until needed and metered to a prime mover driving a line generator at a constant rate to supply power to the power grid or other standard electrical components as needed. This approach will allow for a larger percentage of available wind energy to be converted into practical work due to separating the wind system form the power grid. A much larger wind speed range can be practically used for energy harvesting.

In addition, a larger amount of energy for any given wind speed can be extracted by exposing more blade surface area to the wind compared to the standard three blade concept thereby converting a higher percentage of available wind energy into work than standard wind systems. Therefore, a wind farm producing hydrogen and oxygen gas then converting that potential energy into A/C line current intended for grid distribution will provide more power per year per footprint and dollar invested than a standard wind system connected directly to the power grid making this approach more attractive to investors than the prior art. Also, there is more flexibility regarding siting of wind farms due to the increase energy conversion per a given footprint over prior art. For example, approximately 8 times the amount of power appears possible to extract from a given space in air using this system combined with a wind farm system as compared to the direct power grid approach currently in practice.

However, a broader potential for this system is to separate energy harvesting from consumption and then recycle condensate back to the harvesting site to add to economic and environmental efficiencies. This concept can apply to commercial applications to take advantage of economies of scale allowing remote harvesting in the open ocean or remote land locations. The separation between harvesting and consumption sites can occur at both gas and condensate system storage locations. The harvesting site could include wind, wave, or solar systems collectively or individually.

Wind, wave, and solar activity may fluctuate as environmental conditions change only changing the rate at which potential energy is stored in the form of hydrogen and oxygen. When sufficient qualities are accumulated in the gas storage tanks, hydrogen and oxygen can be shipped to the point of use. Although some energy is used during transport, the expected losses should not be has high as line losses would be if electrical power were distributed over transmission lines to the same location. The point of use could also be equipped with both gas and water storage containers.

Hydrogen and Oxygen under pressure and temperature stored in insulated containers can supply energy to a hybrid cycle conversion system that can employ decompressors and an internal combustion system, such as a reciprocating engine or gas turbine. Potential energy can be converted back into kinetic energy in the form of line current that meets all national electrical codes. Heat present in exhaust gases from the internal combustion process can be transferred through heat exchangers to intake fuel and air converting waste heat into work thereby conserving energy and producing condensate. Condensate collects into a storage container then transfers to a truck, rail, and/or vessel, which then transports back to the harvesting site for recycling thereby minimizing the need and costs of make-up water.

In addition, the line generator, decompression units, gas turbine or reciprocating internal combustion engine, heat exchangers, and condensate recovery tank can be assembled on a mobile platform. Construction of a mobile platform allows for the hybrid cycle power station to be fabricated remotely from the point of use and then delivered to a customer as a unit thus significantly reducing installation times and disruption at the customer's location. The storage tanks can be separable from the mobile platform to allow for routine container exchange. This power plant can provide unprecedented fuel efficiencies for power stations capable of operating at a commercial scale. The system can provide low labor, transport, and maintenance costs with high operating efficiency exploiting free wind, wave, or solar energy. The system can be adjusted in scale to accommodate very small-scale residential usages and very large scale industrial usage. The flexibility of the power conversion system can enable power to be received from wind, wave, or solar generation. Systems can be modified at the user's site to receive hydrogen and oxygen as fuel to drive a power station or to receive A/C power from distribution lines, such as directly from a wind, wave, or solar energy farm. Energy that is varying in voltage, frequency, and current can be converted into a steady output that meets power grid requirements. In addition, the prime mover could be an internal combustion engine, gas turbine, or other prime mover depending upon the need.

It will thus be appreciated that there are numerous potential applications for this technology. By way of example, dirty current can be converted to clean current by hydrogen and oxygen generation as an intermediate step through wind, wave, and solar farms. A farm power station can feed a power grid or sub-station. Dirty current originating from wind, wave, or solar energy can be converted into hydrogen and oxygen, stored, distributed to the point of use, and converted at the point of use into clean current. The point of use may include, for example, a manufacturing facility, office building, public transportation facility, shopping mall, residences or sub-station intended for residential service. Furthermore, high voltage dirty A/C current can be distributed from point of generation from wind farms to the point of use and then converted to clean current to service the point of use. As used above, dirty current can be considered widely fluctuating current sourced by wind, wave, or solar energy in the form of AC or DC. There is no sustainable voltage, frequency, or amperage, and it is not acceptable to the power grid or standard electrical distribution equipment. The phase will be constant for multi phase applications. Clean current is steady A/C current, whether single, two, or three-phase, that meets all regulatory standards for power grid, commercial or facility distribution.

The astute reader will appreciate that demand for efficient and environmentally clean power systems continues to grow in the U.S. and around the world. A conversion to an approach for generating and distributing energy needs to move to a more environmentally sound and efficient system that reduces dependencies on fossil fuels and contributes to controlling inflation currently affected by rising energy costs. The system disclosed and protected hereby can satisfy many of those objectives and can be a key component of an overall renewable energy system that utilizes wind, wave, or solar technology to extract energy from nature and convert it efficiently to commercially usable work.

With certain details and embodiments of the present invention for hybrid cycle electrolysis power systems disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims are intended to define the scope of protection to be afforded to the inventor. Those claims shall be deemed to include equivalent constructions insofar as they do not depart from the spirit and scope of the invention. It must be further noted that a plurality of the following claims express certain elements as means for performing a specific function, at times without the recital of structure or material. As the law demands, these claims shall be construed to cover not only the corresponding structure and material expressly described in this specification but also all equivalents thereof.

I claim as deserving the protection of Letters Patent:

1. A method for generating power comprising the steps of:
feeding water into an electrolyzer;
providing electricity to operate the electrolyzer to split at least some of the water into hydrogen and oxygen; and
decompressing one or both of the hydrogen and oxygen to generate power.

2. The method of claim 1 further comprising the step of pressurizing the water prior to feeding the water into the electrolyzer.

3. The method of claim 1 wherein one or both of the hydrogen and the oxygen are decompressed isentropically and further comprising the step of employing energy from decompressing one or both of the hydrogen or oxygen to power a generator thereby converting energy in the hydrogen and oxygen into work.

4. The method of claim 1 further comprising the steps of disposing at least some of the hydrogen in a hydrogen storage vessel and disposing at least some of the oxygen in an oxygen storage vessel.

5. The method of claim 4 further comprising the step of extracting heat from one or both of the hydrogen or oxygen.

6. The method of claim 5 wherein the step of extracting heat from one or both of the hydrogen or oxygen includes extracting heat by use of at least one heat exchanger.

7. The method of claim 4 further comprising the step of combining the hydrogen and oxygen in an internal combustion process.

8. The method of claim 7 wherein the internal combustion process generates heat and further comprising the step of employing the heat from the internal combustion process to produce work.

9. The method of claim 7 further comprising the step of recovering heat from exhaust gasses from the internal combustion process.

10. The method of claim 9 further comprising the step of recycling heat from exhaust gasses to pre-heat air fed into the internal combustion process.

11. The method of claim 9 wherein the step of recovering heat from exhaust gasses from the internal combustion process includes extracting heat by use of at least one heat exchanger.

12. The method of claim 8 wherein the step of employing the heat from the internal combustion process to produce work comprises employing the heat to drive an electric generator.

13. The method of claim 8 further comprising the step of pre-heating air fed into the internal combustion process using heat from the internal combustion process.

14. The method of claim 10 further comprising the step of pre-compressing air fed into the internal combustion process.

15. The method of claim 1 wherein the step of providing electricity to operate the electrolyzer comprises providing electricity derived at least in part from an energy harvesting method chosen from the group consisting of wind energy harvesting, wave energy harvesting, and solar energy harvesting.
